(19) United States
(12) Patent Application Publication
(10) Pub. No.: US 2023/0090281 A1
(43) Pub. Date: Mar. 23, 2023

(54) PANORAMIC CAMERA SYSTEM FOR ENHANCED SENSING

(71) Applicant: Circle Optics, Inc., Rochester, NY (US)

(72) Inventors: Andrew F. Kurtz, Macedon, NY (US); John Bowron, Burlington (CA); Zakariya Niazi, Rochester, NY (US); Allen Krisiloff, Rochester, NY (US); Christopher M. Muir, Rochester, NY (US); Robert Stanchus, Wolcott, NY (US)

(21) Appl. No.: 17/798,838

(22) PCT Filed: Feb. 9, 2021
(86) PCT No.: PCT/US21/17284

§ 371 Date: Aug. 10, 2022

Related U.S. Application Data
(63) Continuation of application No. PCT/US2020/039200, filed on Jun. 23, 2020.
Application No. PCT/US2020/039200 is a continuation of application No. PCT/US2020/039201, filed on Jun. 23, 2020.
Application No. PCT/US2020/039201 is a continuation of application No. PCT/US2020/039197, filed on Jun. 23, 2020.
Application No. PCT/US2020/039197 is a continuation of application No. PCT/US2020/066702, filed on Dec. 22, 2020.
(60) Provisional application No. 62/972,532, filed on Feb. 10, 2020.

(51) Int. Cl. G02B 13/06; G02B 13/22

(52) U.S. Cl. CPC G02B 13/06; G02B 13/22

(57) ABSTRACT

This application generally describes an imaging system, such as a multi-camera imaging system. The imaging system can include a plurality of channels and individual of the channels can include an objective lens and a relay optical system. The object lens images received light on a first image plane, as a first image, and the relay optical system images the first image on a second image plane, as a second, magnified image. In examples, the object lens and the relay optical system make up an optically coherent system.

### CROSS REFERENCE TO RELATED APPLICATIONS

This application is the National Stage of International Application No. PCT/US2021/17284, filed Feb. 9, 2021, which claims priority to and the benefit of: International Patent Application No. PCT/US20/39197, filed Jun. 23, 2020, entitled “Opto-Mechanics of Panoramic Capture Devices with Abutting Cameras,” International Patent Application No. PCT/US2020/39200, filed Jun. 23, 2020, entitled “Multi-camera Panoramic Image Capture Devices with a Faceted Dome;” International Patent Application No. PCT/US2020/39201, filed Jun. 23, 2020, entitled “Lens Design for Low Parallax Panoramic Camera Systems;” International Patent Application No. PCT/US2020/66702, filed Dec. 22, 2020, entitled, “Mounting Systems for Multi-Camera Imagers”; and U.S. Provisional Patent Application Ser. No. 62/972,532, filed Feb. 10, 2020, entitled “Integrated Depth Sensing and Panoramic Camera System.” The four listed International applications each claims priority to U.S. Provisional Patent Application Ser. No. 62/952,973, filed Dec. 23, 2019, entitled “Opto-Mechanics of Panoramic Capture Devices with Abutting Cameras;” and to U.S. Provisional Patent Application Ser. No. 62/952,983, filed Dec. 23, 2019, entitled “Multi-camera Panoramic Image Capture Devices with a Faceted Dome.” The first three International Applications listed above each also claims priority to U.S. Provisional Patent Application Ser. No. 62/865,741, filed Jun. 24, 2019. The entirety of each of the applications listed above is incorporated herein by reference.

### TECHNICAL FIELD

The present disclosure relates to panoramic low-parallax multi-camera capture devices having a plurality of adjacent and abutting polygonal cameras. The disclosure also relates the optical and opto-mechanical designs of cameras that capture incident light from a polygonal shaped field of view to form a polygonal shaped image that also provides enhanced sensing that can enable improved situational awareness of an environment or scene or events transpiring therein.

### BACKGROUND

Although panoramic cameras have been around for decades, the technology is evolving to fulfill enhanced and emerging market opportunities, including those in image capture for cinema, virtual reality, sports and entertainment, security, mapping, and autonomous vehicular navigation. Panoramic cameras have substantial value because of their ability to simultaneously capture wide field of view images. The earliest such example is the fisheye lens, which is an ultra-wide-angle lens that produces strong visual distortion that is intended to create a wide panoramic or hemispherical image. While the field of view (FOV) of a fisheye lens is usually between 100 and 180 degrees, the approach has been extended to yet larger angles, including into the 220-270° range, as provided by Y. Shimizu in U.S. Pat. No. 3,524,697. As an alternative, there are mirror or reflective based cameras that capture annular panoramic images, such as the system suggested by P. Greguss in U.S. Pat. No. 4,930,864. As another example, U.S. Pat. No. 9,451,162 to A. Van Hoff et al., of Jaunt Inc., provides for a panoramic multi-camera device in which a plurality of cameras are arranged around a sphere or a circumference of a sphere, in a sparsely populated manner, but with the individual cameras capturing images with overlapping FOVs, so as in aggregate, to enable capture of complete panoramic images.

There are also panoramic multi-camera devices in which a plurality of cameras are arranged around a sphere or a circumference of a sphere, such that adjacent cameras are abutting along a part or the whole of adjacent edges. As examples, U.S. Pat. No. 7,515,177 by K. Yoshikawa and U.S. Pat. No. 10,341,559 by Z. Niazi depict an imaging device with a multitude of adjacent image pickup units (cameras), for which design goals include reducing parallax errors for images captured by adjacent cameras. Parallax is the visual perception that the position or direction of an object appears to be different when viewed from different positions. In the example of Yoshikawa, mages are collected from cameras having partially overlapping fields of view, to compensate for mechanical errors. The presence of parallax errors significantly slow efforts to properly combine, stitch, and synthesize larger overall panoramic images from the images captured by adjacent cameras. However, in other systems, the presence of parallax image differences can provide useful data. For example, in U.S. Pat. No. 6,947,059, by D. Pierce et al., a multitude of offset positioned cameras capture images panoramically, with adjacent cameras capturing images with partial image overlap, to provide stereoscopic (or depth) image capture throughput a panoramic FOV.

Other image capture technologies are known for capturing depth or motion information from an environment, such as the relative distance or position of objects from the camera. The resulting data can then be used to enable or enhance situational awareness of the environment or scene, or events transpiring therein. The resulting optical or image data can be used by autonomous vehicles, including drones or robots, or to inform drivers or pilots of aircraft, cars or trucks, or flying vehicles, or for numerous other purposes.

As one approach, light field image capture enables image data from a multitude of planes to be captured simultaneously. This can allow the depth or resolution of objects to be subsequently examined in detail. Separately, autonomous vehicular navigation is also being enabled, in part, by an evolution of spatial detection technologies, including, particularly those for LIDAR. LIDAR, which is an acronym for a set of Light-Detection-and-Ranging technologies, is a term used for sensors that emit pulses of light and measure the time delay between emission and reception of these pulses. LIDAR is a form of remote sensing that enables creation of a three-dimensional map of a volume or area in proximity to a LIDAR unit or the accompanying object. In the field, these maps are known as point clouds, which are a collection of points that represent a 3D shape or feature. Each point has its own set of X, Y and Z coordinates and in some cases additional attributes. While, the rapid development of LIDAR is presently being propelled by efforts to enable autonomous vehicular navigation, the technology can have broader potential uses, including for robotic navigation, mapping, archaeology, and construction. As yet another alternative, neuromorphic or event sensors, including the Oculi SPU, which are much more sensitive than standard image sensors, relative to signal strength or temporal response, can be used to provide optical or image data for enhanced situational awareness.

However, capture and processing of LIDAR or optical point cloud data in real time to assist vehicular navigation can be particularly challenging, and thus LIDAR or event sensing resolution, as compared to images captured by cameras, is typically modest. For circumstances or other applications with less urgency, the geometric calibration, combination, and comparison of images and depth or event data of objects within a scene can be valuable. However, there can be significant problems in dealing with offset alignment or parallax errors when using proximate (but not integrated) or sequentially re-positioned camera and depth or event sensing systems. Thus, there are opportunities to provide enhanced systems for capturing combined image data and depth data of objects in a scene or environment, and particularly for panoramic image and depth or event data capture.

### BRIEF DESCRIPTION OF THE DRAWINGS

FIG. 1 depicts a portion of a multi-camera capture device, and specifically two adjacent cameras thereof.

FIGS. 2A and 2B depict portions of low-parallax camera lens assemblies in cross-section, including lens elements and ray paths.

FIG. 3 depicts a cross-sectional view of a portion of a multi-camera capture device showing FOV overlap, Fields of view, overlap, seams, and blind regions.

FIG. 4 depicts the general concept of laser range finding or LIDAR optical system.

FIG. 5A and FIG. 5B depict the optical geometry for fields of view for adjacent hexagonal and pentagonal lenses, as can occur with a device having the geometry of a truncated icosahedron. FIG. 5B depicts an expanded area of FIG. 5A with greater detail.

FIG. 5C depicts an example of a low parallax (LP) volume located near both a paraxial NP point or entrance pupil and a device center.

FIG. 5D depicts parallax differences for two adjacent cameras, relative to a center of perspective.

FIG. 5E depicts front color at an edge of an outer compressor lens element.

FIG. 5F depicts a graph of the calculated residual for a center of a perspective variation for a low parallax camera or objective lens of the type depicted in FIGS. 2A and 2B.

FIG. 6 depicts distortion correction curves plotted on a graph showing a percentage of distortion relative to a fractional field.

FIG. 7 depicts fields of view for adjacent cameras, including both Core and Extended fields of view (FOV), both of which can be useful for the design of an optimized panoramic multi-camera capture device.

FIG. 8 depicts an improved design for a low-parallax camera lens or objective lens with a multi-compressor lens group.

FIG. 9 depicts an improved camera lens design, acting as an objective lens, in combination with a refractive relay optical imaging system.

FIG. 10 depicts an electronics system diagram for a multi-camera capture device.

FIG. 11 depicts a cross-sectional view of an improved opto-mechanics construction for a multi-camera capture device, and a 3D view of a camera channel thereof.

FIG. 12A depicts a perspective view of an alternate design to that shown in FIG. 11, for the mounting of the camera channels to each other and to a central support.

FIG. 12B depicts a perspective view of a portion of the alternate design of FIG. 12A, providing greater detail on the interface of a secondary channel to the primary channel.

FIG. 13 depicts a view of another alternate design approach for a central support to which camera channels can be mounted.

FIG. 14 depicts an alternate configuration for an improved multi-camera capture device.

FIG. 15A depicts a camera objective lens paired with a relay optical system including a beam splitter to direct image light into an additional optical sub-system.

FIG. 15B depicts an alternate example optical design for a camera objective lens paired with a relay optical system.

FIG. 16A depicts a relay optical system portion of the type shown in the systems of FIGS. 15A,B, but further including a laser range finding subsystem having a MEMs mirror.

FIG. 16B depicts a relay optical system portion of the type shown in the systems of FIGS. 15A,B, but further including a laser range finding subsystem having an optical phased array.

FIG. 16C depicts a conceptual integration of the IR depth sensing optical path with a camera objective lens used in low parallax imaging.

FIG. 16D depicts a relay optical system portion of the type shown in the systems of FIGS. 15A,B, but further including a laser range finding subsystem having a laser array light source.

FIG. 16E depicts a relay optical system portion of the type shown in FIGS. 15A and 15B, further including a depth sensing system having an image sensor and light field micro-optics.

### DETAILED DESCRIPTION OF THE INVENTION

As is generally understood in the field of optics, a lens or lens assembly typically comprises a system or device having multiple lens elements which are mounted into a lens barrel or housing, and which work together to produce an optical image. An imaging lens captures a portion of the light coming from an object or plurality of objects that reside in object space at some distance(s) from the lens system. The imaging lens can then form an image of these objects at an output “plane”; the image having a finite size that depends on the magnification, as determined by the focal length of the imaging lens and the conjugate distances to the object(s) and image plane, relative to that focal length. The amount of image light that transits the lens, from object to image, depends in large part on the size of the aperture stop of the imaging lens, which is typically quantified by one or more values for a numerical aperture (NA) or an f-number (F # or F/#).

The image quality provided by the imaging lens depends on numerous properties of the lens design, including the selection of optical materials used in the design, the size, shapes (or curvatures) and thicknesses of the lens elements, the relative spacing of the lens elements one to another, the spectral bandwidth, polarization, light load (power or flux) of the transiting light, optical diffraction or scattering, and/or lens manufacturing tolerances or errors. The image quality is typically described or quantified in terms of lens aberrations (e.g., spherical, coma, astigmatism, or distortion), or the relative size of the resolvable spots provided by the lens. The resolution provided by an imaging lens is typically quantified by the modulation transfer function (MTF).

In a typical electronic or digital camera, an image sensor is nominally located at the image plane. This image sensor is typically a CCD or CMOS device, which is physically attached to a heat sink or other heat removal means, and also includes electronics that provide power to the sensor, and read-out and communications circuitry that provide the image data to data storage or image processing electronics. The image sensor typically has a color filter array (CFA), such as a Bayer filter within the device, with the color filter pixels aligned in registration with the image pixels to provide an array of RGB (Red, Green, Blue) pixels. Alternative filter array patterns, including the CYGM filter (cyan, yellow, green, magenta) or an RGBW filter array (W=white), can be used instead.

In typical use, many digital cameras are used by people or remote systems in relative isolation, to capture images or pictures of a scene, without any dependence or interaction with any other camera devices. In some cases, such as surveillance or security, the operation of a camera may be directed by people or algorithms based on image content seen from another camera that has already captured overlapping, adjacent, or proximate image content. In another example, people capture panoramic images of a scene with an extended or wide FOV, such as a landscape scene, by sequentially capturing a sequence of adjacent images, while manually or automatically moving or pivoting to frame the adjacent images. Afterwards, image processing software, such as Photoshop or Lightroom, can be used to stitch, mosaic, or tile the adjacent images together to portray the larger extended scene. Image stitching or photo stitching is the process of combining multiple photographic images with overlapping fields of view to produce a segmented panorama or high-resolution image. Image quality improvements, including exposure or color corrections, can also be applied, either in real time, or in a post processing or image rendering phase, or a combination thereof.

Unless the objects in a scene are directionally illuminated and/or have a directional optical response (e.g., such as with reflectance), the available light is plenoptic, meaning that there is light travelling in every direction, or nearly so, in a given space or environment. A camera can then sample a subset of this light, as image light, with which it provides a resulting image that shows a given view or perspective of the different objects in the scene at one or more instants in time. If the camera is moved to a different nearby location and used to capture another image of part of that same scene, both the apparent perspectives and relative positioning of the objects will change. In the latter case, one object may now partially occlude another, while a previously hidden object becomes at least partially visible. These differences in the apparent position or direction of an object are known as parallax. In particular, parallax is a displacement or difference in the apparent position of an object viewed along two different lines of sight and is measured by the angle or semi-angle of inclination between those two lines.

In a stereoscopic image capture or projection system, dual view parallax is a cue, along with shadowing, occlusion, and perspective, that can provide a sense of depth. For example, in a stereo (3D) projection system, polarization or spectrally encoded image pairs can be overlap projected onto a screen to be viewed by audience members wearing appropriate glasses. The amount of parallax can have an optimal range, outside of which, the resulting sense of depth can be too small to really be noticed by the audience members, or too large to properly be fused by the human visual system.

Whereas, in a panoramic image capture application, parallax differences can be regarded as an error that can complicate both image stitching and appearance. In the example of an individual manually capturing a panoramic sequence of landscape images, the visual differences in perspective or parallax across images may be too small to notice if the objects in the scene are sufficiently distant (e.g., optically at infinity). An integrated panoramic capture device with a rotating camera or multiple cameras has the potential to continuously capture real time image data at high resolution without being dependent on the uncertainties of manual capture. But such a device can also introduce its own visual disparities, image artifacts, or errors, including those of parallax, perspective, and exposure. Although the resulting images can often be successfully stitched together with image processing algorithms, the input image errors complicate and lengthen image processing time, while sometimes leaving visually obvious residual errors.

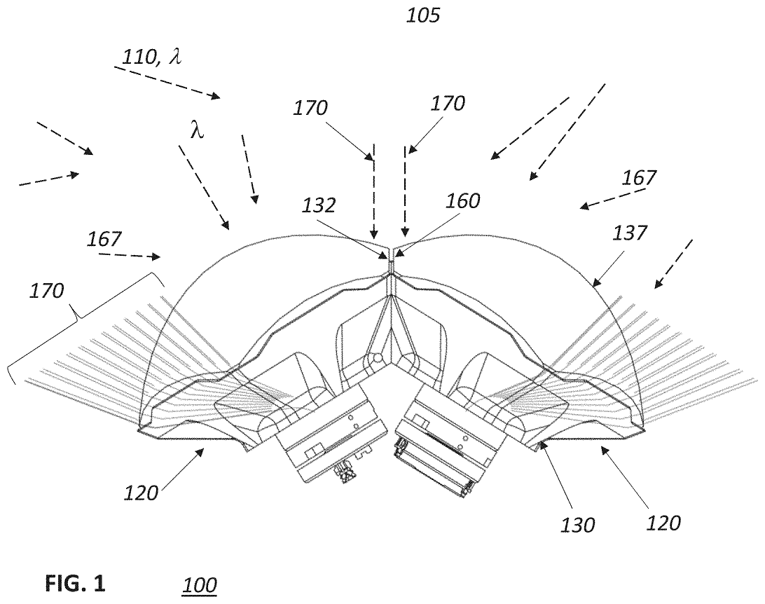

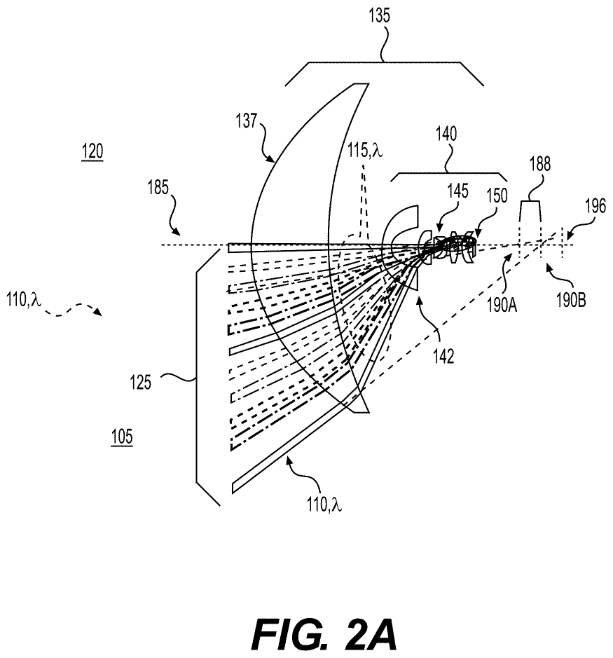

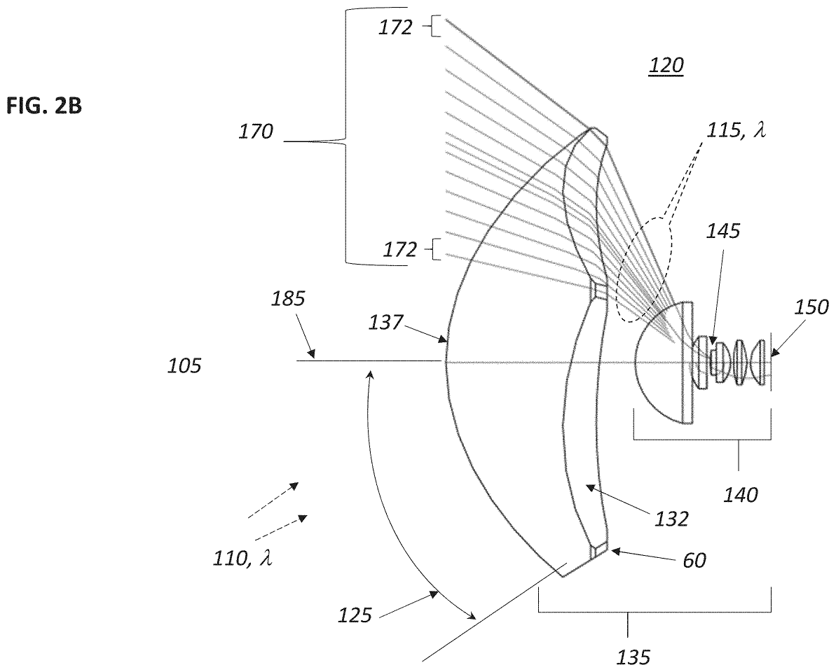

To provide context, FIG. 1 depicts a portion of an improved integrated panoramic multi-camera capture device 100 having two adjacent cameras 120 in housings 130 which are designed for reduced parallax image capture. These cameras are alternately referred to as image pick-up units, or camera channels, or objective lens systems. The cameras 120 each have a plurality of lens elements (see FIG. 2) that are mounted within a lens barrel or housing 130. The adjacent outer lens elements 137 have adjacent beveled edges 132 and are proximately located, one camera channel to another, but which may not be in contact, and thus are separated by a gap or seam 160 of finite width. Some portion of the available light (□), or light rays 110, from a scene or object space 105 will enter a camera 120 to become image light that was captured within a constrained FOV and directed to an image plane, while other light rays will miss the cameras entirely. Some light rays 110 will propagate into the camera and transit the constituent lens elements as edge-of-field chief rays 170, or perimeter rays, while other light rays can potentially propagate through the lens elements to create stray or ghost light and erroneous bright spots or images. As an example, some light rays (167) that are incident at large angles to the outer surface of an outer lens element 137 can transit a complex path through the lens elements of a camera and create a detectable ghost image at the image plane 150.

In greater detail, FIG. 2A depicts a cross-section of part of a camera 120 having a set of lens elements 135 mounted in a housing (130, not shown) within a portion of an integrated panoramic multi-camera capture device 100. A fan of light rays 110 from object space 105, spanning the range from on axis to full field off axis chief rays, are incident onto the outer lens element 137, and are refracted and transmitted inwards. This image light 115 that is refracted and transmitted through further inner lens elements 140, through an aperture stop 145, converges to a focused image at or near an image plane 150, where an image sensor (not shown) is typically located. The lens system 120 of FIG. 2A can also be defined as having a lens form that consists of outer lens element 137 or compressor lens element, and inner lens elements 140, the latter of which can also be defined as consisting of a pre-stop wide angle lens group, and a post-stop eyepiece-like lens group. This compressor lens element (137) directs the image light 115 sharply inwards, compressing the light, to both help enable the overall lens assembly to provide a short focal length, while also enabling the needed room for the camera lens housing or barrel to provide the mechanical features necessary to both hold or mount the lens elements and to interface properly with the barrel or housing of an adjacent camera. The image light that transited a camera lens assembly from the outer lens element 137 to the image plane 150 will provide an image having an image quality, that can be quantified by an image resolution, image contrast, a depth of focus, and other attributes, whose quality was defined by the optical aberrations (e.g., astigmatism, distortion, or spherical) and chromatic or spectral aberrations, encountered by the transiting light at each of the lens elements (137, 140) within a camera 120. FIG. 2B depicts a fan of chief rays 170, or perimeter rays, incident along or near a beveled edge 132 of the outer lens element 137 of the camera optics (120) depicted in FIG. 2A. FIG. 2B also depicts a portion of a captured, polygonal shaped or asymmetrical, FOV 125, that extends from the optical axis 185 to a line coincident with an edge ray.

In the camera lens design depicted in FIG. 2A, the outer lens element 137 functions as a compressor lens element that redirects the transiting image light 115 towards a second lens element 142, which is the first lens element of the group of inner lens elements 140. In this design, this second lens element 142 has a very concave shape that is reminiscent of the outer lens element used in a fish-eye type imaging lens. This compressor lens element directs the image light 115 sharply inwards, or bends the light rays, to both help enable the overall lens assembly to provide a short focal length, while also enabling the needed room for the camera lens housing 130 or barrel to provide the mechanical features necessary to both hold or mount the lens elements 135 and to interface properly with the barrel or housing of an adjacent camera. However, with a good lens and opto-mechanical design, and an appropriate sensor choice, a camera 120 can be designed with a lens assembly that supports an image resolution of 20-30 pixels/degree, to as much as 110 pixels/degree, or greater, depending on the application and the device configuration.

The resultant image quality from these cameras will also depend on the light that scatters at surfaces, or within the lens elements, and on the light that is reflected or transmitted at each lens surface. The surface transmittance and camera lens system efficiency can be improved by the use of anti-reflection (AR) coatings. The image quality can also depend on the outcomes of non-image light. Considering again FIG. 1, other portions of the available light can be predominately reflected off of the outer lens element 137. Yet other light that enters a camera 120 can be blocked or absorbed by some combination of blackened areas (not shown) that are provided at or near the aperture stop, the inner lens barrel surfaces, the lens element edges, internal baffles or light trapping features, a field stop, or other surfaces. Yet other light that enters a camera can become stray light or ghost light 167 that is also potentially visible at the image plane.

The aggregate image quality obtained by a plurality of adjacent cameras 120 within an improved integrated panoramic multi-camera capture device 100 (e.g., FIG. 1) can also depend upon a variety of other factors including the camera to camera variations in the focal length and/or track length, and magnification, provided by the individual cameras. These parameters can vary depending on factors including the variations of the glass refractive indices, variations in lens element thicknesses and curvatures, and variations in lens element mounting. As an example, images that are tiled or mosaiced together from a plurality of adjacent cameras will typically need to be corrected, one to the other, to compensate for image size variations that originate with camera magnification differences (e.g., ±2%).

The images produced by a plurality of cameras in an integrated panoramic multi-camera capture device 100 can also vary in other ways that effect image quality and image mosaicing or tiling. In particular, the directional pointing or collection of image light through the lens elements to the image sensor of any given camera 120 can vary, such that the camera captures an angularly skewed or asymmetrical FOV (FOV↔) or mis-sized FOV (FOV±). The lens pointing variations can occur during fabrication of the camera (e.g., lens elements, sensor, and housing) or during the combined assembly of the multiple cameras into an integrated panoramic multi-camera capture device 100, such that the alignment of the individual cameras is skewed by misalignments or mounting stresses. When these camera pointing errors are combined with the presence of the seams 160 between cameras 120, images for portions of an available landscape or panoramic FOV that may be captured, may instead be missed or captured improperly. The variabilities of the camera pointing, and seams can be exacerbated by mechanical shifts and distortions that are caused by internal or external environmental factors, such as heat or light (e.g., image content), and particularly asymmetrical loads thereof.

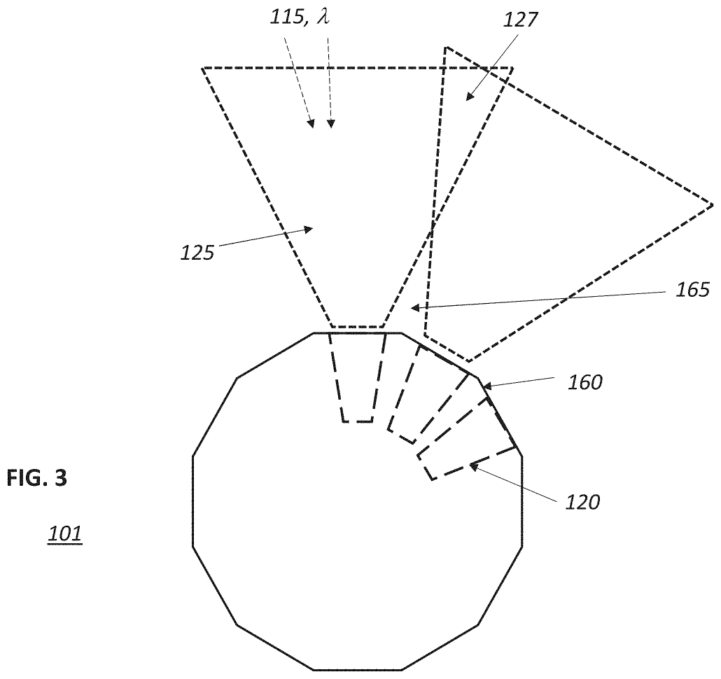

In comparison to the FIG. 1 system, in a typical commercially available panoramic camera, the seams between cameras are outright gaps that can be 30-50 mm wide, or more. In particular, as shown in FIG. 3, a panoramic multi-camera capture device 101 can have adjacent cameras 120 or camera channels separated by large gaps or seams 160, between which there are blind spots or regions 165 from which neither camera can capture images. The actual physical seams 160 between adjacent camera channels or outer lens elements 137 (FIG. 1 and FIG. 3) can be measured in various ways; as an actual physical distance between adjacent lens elements or lens housings, as an angular extent of lost FOV, or as a number of “lost” pixels. However, the optical seam, as the distance between outer chief rays of one camera to another can be larger yet, due to any gaps in light acceptance caused by vignetting or coating limits. For example, anti-reflection (AR) coatings are not typically deposited to the edges of optics, but an offsetting margin is provided, to provide a coated clear aperture (CA).

To compensate for both camera misalignments and the large seams 160, and to reduce the size of the blind regions 165, the typical panoramic multi-camera capture devices 101 (FIG. 3) have each of the individual cameras 120 capture image light 115 from wide FOVs 125 that provide overlap 127, so that blind regions 165 are reduced, and the potential capturable image content that is lost is small. As another example, in most of the commercially available multi-camera capture devices 101, the gaps are 25-50+ mm wide, and the compensating FOV overlap between cameras is likewise large; e.g., the portions of the FOVs 125 that are overlapping and are captured by two adjacent cameras 120 can be as much as 10-50% of a camera's FOV. The presence of such large image overlaps from shared FOVs 125 wastes potential image resolution and increases the image processing and image stitching time, while introducing significant image parallax and perspective errors. These errors complicate image stitching, as the errors must be corrected or averaged during the stitching process. In such systems, the parallax is not predictable because it changes as a function of object distance. If the object distance is known, the parallax can be predicted for given fields of view and spacing between cameras. But because the object distance is not typically known, parallax errors then complicate image stitching. Optical flow and common stitching algorithms determine an object depth and enable image stitching, but with processing power and time burdens.

Similarly, in a panoramic multi-camera capture device 100, of the type of FIG. 1, with closely integrated cameras, the width and construction at the seams 160 can be an important factor in the operation of the entire device. However, the seams can be made smaller than in FIG. 3, with the effective optical seam width between the FOV edges of two adjacent cameras determined by both optical and mechanical contributions. For example, by using standard optical engineering practices to build lens assemblies in housings, the mechanical width of the seams 160 between the outer lens elements 137 of adjacent cameras might be reduced to 4-6 mm. For example, it is standard practice to assemble lens elements into a lens barrel or housing that has a minimum radial width of 1-1.5 mm, particularly near the outermost lens element. Then accounting for standard coated clear apertures or coating margins, and accounting for possible vignetting, aberrations of the entrance pupil, front color, chip edges, and trying to mount adjacent lens assemblies or housings in proximity by standard techniques. Thus, when accounting for both optics and mechanics, an optical seam width between adjacent lenses can easily be 8-12 mm or more.

Wide field of view imaging can be useful for cinematic or VR image capture, sports or event imaging, mapping or photogrammetry, security or surveillance, and/or numerous other applications. Broadly speaking, imaging technologies such as that of FIG. 1 can also enable situational awareness, which is the perception of environmental elements and events with respect to time or space, the comprehension of their meaning, and the projection of their future status. For security applications, situational awareness includes the use of a sensory system to scan the environment with the purpose of identifying threats in the present or anticipating threats based on projections into the future. Optical sensing for situational awareness can be enabled by traditional imaging sensors and camera systems, by ranging technologies such as LIDAR, radar, sonar, or the like, and/or by emerging technologies such as event sensors.

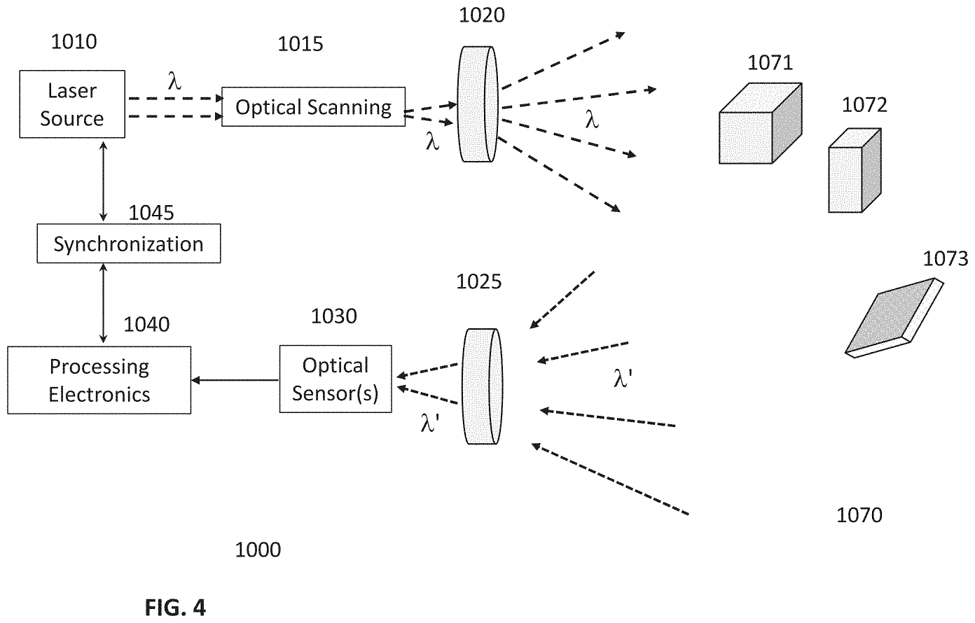

As an example, by comparison to panoramic multi-camera capture devices, which optically sample an environment in a passive manner, by collecting and imaging a portion of the plenoptic light, LIDAR systems are used to purposefully illuminate, scan, or sweep an environment or scene with laser light. This emitted laser light reflects off objects in the environment and returns to a sensor of the LIDAR system. The sensor detects the return light and generates a signal that may distinguish the return light from ambient light. The LIDAR system also determines a position or motion velocity and trajectory for the detected objects within a detectable range from the LIDAR device. LIDAR is similar to laser range finding, but as commonly understood, is expanded to detect the position of objects throughout a three-dimensional environment. For example, as shown in FIG. 4, a typical LIDAR system 1000 includes a laser light source 1010 that emits laser light (λ) which is directed to illuminate objects (171-173) in an environment 1070. The illuminating laser light, whether scanned, swept, or flashed, can be modified by illumination optics 1020, to illuminate a portion of the environment 1070. The laser light (λ) can then be scattered, reflected, or diffracted from these objects, and a portion of that redirected laser light (λ′) can then be collected by optics 1025 onto an optical sensor 1030. The resulting signals can be examined by processing electronics 1040 to determine the relative positions of objects in a scene or environment.

Alternately, as provided by the present invention, technologies for enabling enhanced situational awareness, such as large, high resolution image sensors, event sensors, LIDAR or laser range finding optics, light field or other depth sensing optics, can be integrated into improved low-parallax multi-camera panoramic capture devices (300) having appropriately designed optics. An improved panoramic multi-camera capture device can have a plurality of cameras arranged around a spherical or polyhedral shape, or a circumference of a sphere to capture a 360-degree panoramic FOV. A polyhedron is a three-dimensional solid consisting of a collection of polygons that are contiguous at the edges. One polyhedral shape is that of a dodecahedron, which has 12 sides, each shaped as a regular pentagon. A panoramic multi-camera capture device formed to the dodecahedron shape has cameras with a pentagonally shaped outer lens elements that nominally image a 69.1° full width field of view. Another shape is that of a truncated icosahedron, like a soccer ball, which has a combination of 12 regular pentagonal sides or faces, 20 regular hexagonal sides or faces, 60 vertices, and 90 edges. More complex shapes, with many more sides or facets, such as regular polyhedra, Goldberg polyhedra, or shapes with octagonal sides, or even some irregular polyhedral shapes, can also be useful. Typically, a 360° polyhedral camera will not capture a full spherical FOV as at least part of one facet is sacrificed to allow for support features, such as a mounting post.

As depicted in FIG. 1 and FIG. 2B, a camera channel 120 can resemble a frustum, or a portion thereof, where a frustum is a geometric solid (normally a cone or pyramid) that lies between one or two parallel planes that cut through it. In that context, a fan of chief rays 170 corresponding to a polygonal edge, can be refracted by an outer compressor lens element 137 to nominally match the frustum edges in polyhedral geometries.

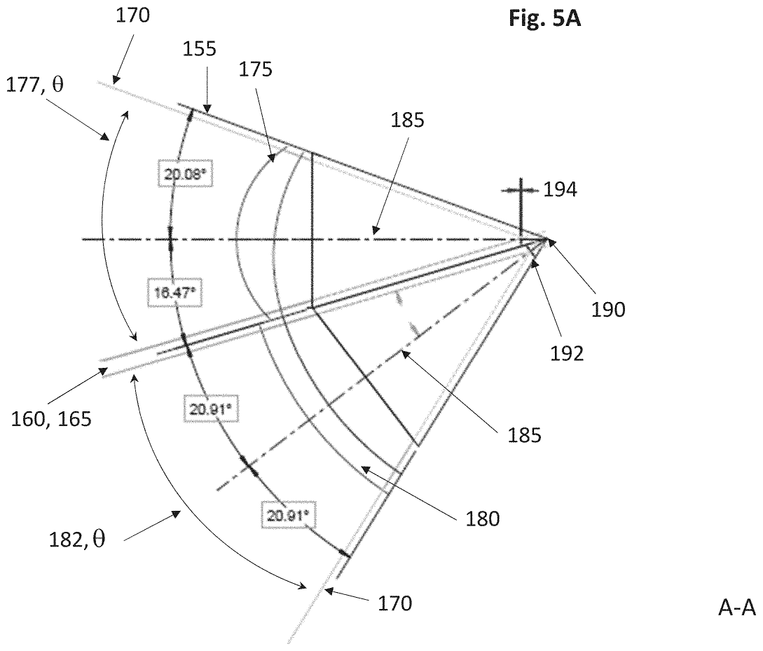

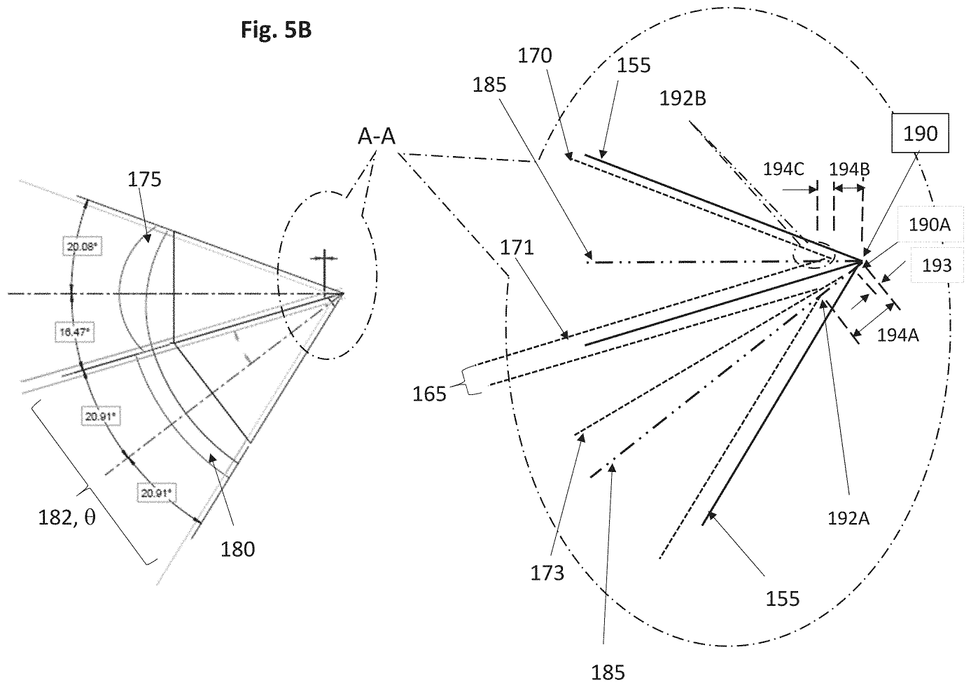

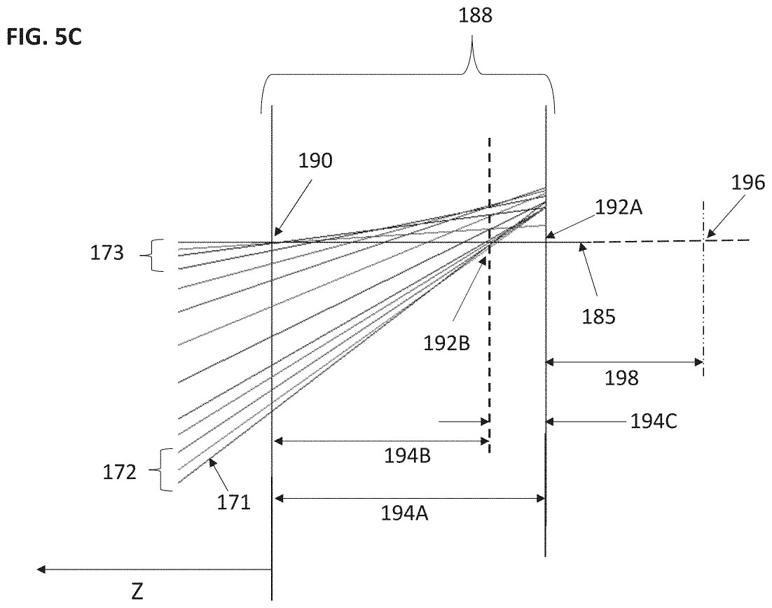

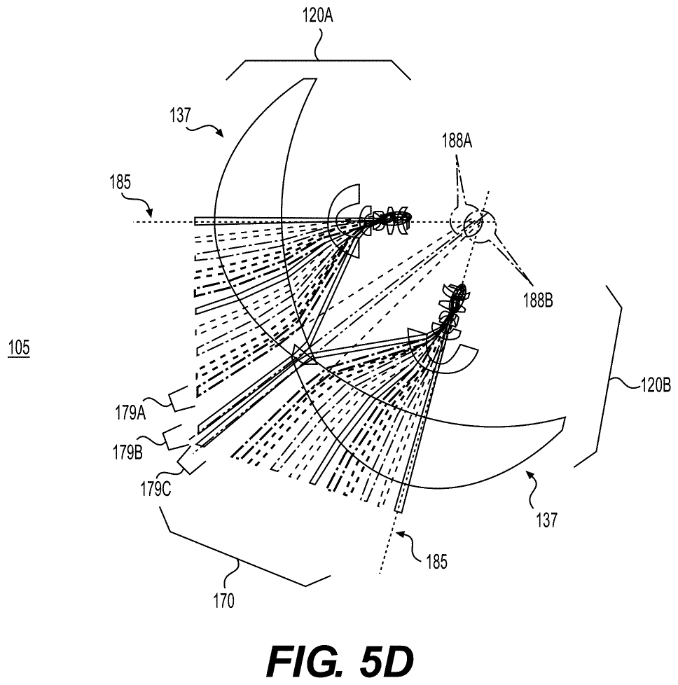

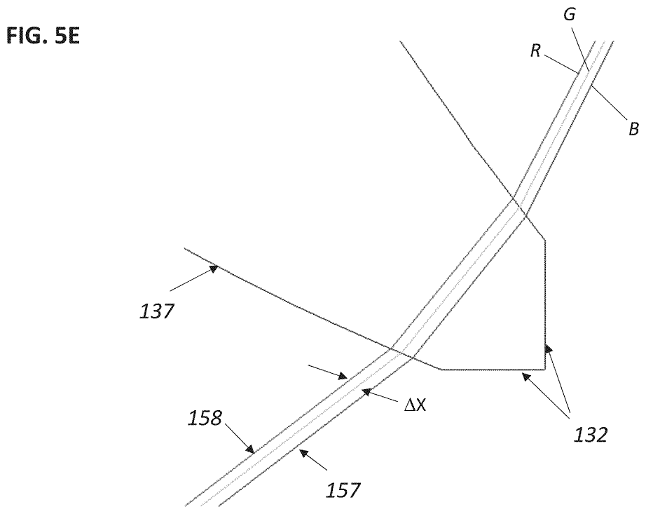

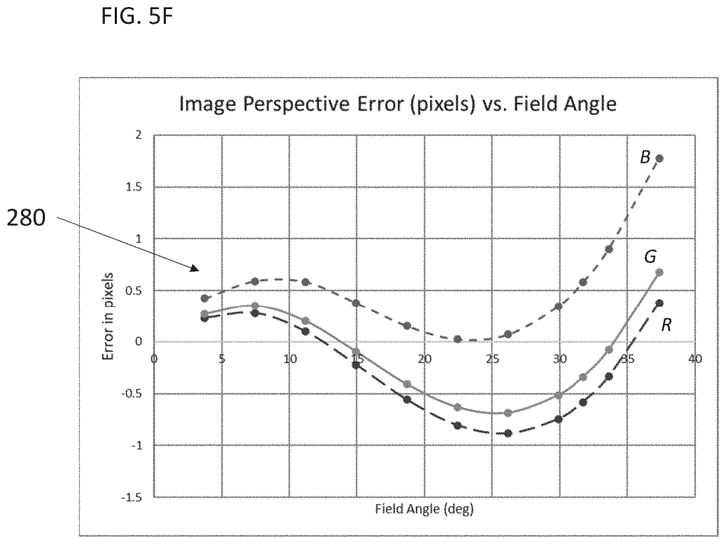

To help illustrate some issues relating to camera geometry, FIG. 5A illustrates a cross-sections of a pentagonal lens 175 capturing a pentagonal FOV 177 and a hexagonal lens 180 capturing a hexagonal FOV 182, representing a pair of adjacent cameras whose outer lens elements have pentagonal and hexagonal shapes, as can occur with a truncated icosahedron, or soccer ball type panoramic multi-camera capture devices (e.g., 100, 300). The theoretical hexagonal FOV 182 spans a half FOV of 20.9°, or a full FOV of 41.8° (θ₁) along the sides, although the FOV near the vertices is larger. The pentagonal FOV 177 supports 36.55° FOV (θ₂) within a circular region, and larger FOVs near the corners or vertices. Notably, in this cross-section, the pentagonal FOV 177 is asymmetrical, supporting a 20-degree FOV on one side of an optical axis 185, and only a 16.5-degree FOV on the other side of the optical axis.

Optical lenses are typically designed using programs such as ZEMAX or Code V. Design success typically depends, in part, on selecting the best or most appropriate lens parameters, identified as operands, to use in the merit function. This is also true when designing a lens system for an improved low-parallax multi-camera panoramic capture device (300), for which there are several factors that affect performance (including, particularly parallax) and several parameters that can be individually or collectively optimized, so as to control it. One approach targets optimization of the “NP” point, or more significantly, variants thereof.

As background, in the field of optics, there is a concept of the entrance pupil, which is a projected image of the aperture stop as seen from object space, or a virtual aperture which the imaged light rays from object space appear to propagate towards before any refraction by the first lens element. By standard practice, the location of the entrance pupil can be found by identifying a paraxial chief ray from object space 105, that transits through the center of the aperture stop, and projecting or extending its object space direction forward to the location where it hits the optical axis 185. In optics, incident Gauss or paraxial rays are understood to reside within an angular range ≤10° from the optical axis, and correspond to rays that are directed towards the center of the aperture stop, and which also define the entrance pupil position. Depending on the lens properties, the entrance pupil may be bigger or smaller than the aperture stop, and located in front of, or behind, the aperture stop.

By comparison, in the field of low-parallax cameras, there is a concept of a no-parallax (NP) point, or viewpoint center. Conceptually, the “NP Point” has been associated with a high FOV chief ray or principal ray incident at or near the outer edge of the outermost lens element, and projecting or extending its object space direction forward to the location where it hits the optical axis 185. For example, depending on the design, camera channels in a panoramic multi-camera capture device can support half FOVs with non-paraxial chief rays at angles >31° for a dodecahedron type system or >20° for a truncated icosahedron type system. This concept of the NP point projection has been applied to the design of panoramic multi-camera capture devices, relative to the expectations for chief ray propagation and parallax control for adjacent optical systems (cameras). It is also stated that if a camera is pivoted about the NP point, or a plurality of camera's appear to rotate about a common NP point, then parallax errors will be reduced, and images can be aligned with little or no parallax error or perspective differences. But in the field of low parallax cameras, the NP point has also been equated to the entrance pupil, and the axial location of the entrance pupil that is estimated using a first order optics tangent relationship between a projection of a paraxial field angle and the incident ray height at the first lens element (see FIGS. 2A, 2B).

Thus, confusingly, in the field of designing of low-parallax cameras, the NP point has also been previously associated with both with the projection of edge of FOV chief rays and the projection of chief rays that are within the Gauss or paraxial regime. As will be seen, in actuality, they both have value. In particular, an NP point associated with the paraxial entrance pupil can be helpful in developing initial specifications for designing the lens, and for describing the lens. An NP point associated with non-paraxial edge of field chief rays can be useful in targeting and understanding parallax performance and in defining the conical volume or frustum that the lens assembly can reside in.

The projection of these non-paraxial chief rays can miss the paraxial chief ray defined entrance pupil because of both lens aberrations and practical geometry related factors associated with these lens systems. Relative to the former, in a well-designed lens, image quality at an image plane is typically prioritized by limiting the impact of aberrations on resolution, telecentricity, and other attributes. Within a lens system, aberrations at interim surfaces, including the aperture stop, can vary widely, as the emphasis is on the net sums at the image plane. Aberrations at the aperture stop are often somewhat controlled to avoid vignetting, but a non-paraxial chief ray need not transit the center of the aperture stop or the projected paraxially located entrance pupil.

To expand on these concepts, and to enable the design of improved low parallax lens systems, it is noted that the camera lens system 120 in FIG. 2A depicts both a first NP point 190A, corresponding to the entrance pupil as defined by a vectoral projection of paraxial chief rays from object space 105, and an offset second NP point 190B, corresponding to a vectoral projection of a non-paraxial chief rays from object space. Both of these ray projections cross the optical axis 185 in locations behind both the lens system and the image plane 150. As will be subsequently discussed, the ray behavior in the region between and proximate to the projected points 190A and 190B can be complicated and neither projected location or point has a definitive value or size. A projection of a chief ray will cross the optical axis at a point, but a projection of a group of chief rays will converge towards the optical axis and cross at different locations, that can be tightly clustered (e.g., within a few or tens of microns), where the extent or size of that “point” can depends on the collection of proximate chief rays used in the analysis. Whereas, when designing low parallax imaging lenses that image large FOVs, the axial distance or difference between the NP points 190A and 190B that are provided by the projected paraxial and non-paraxial chief rays can be significantly larger (e.g., millimeters). Thus, as will also be discussed, the axial difference represents a valuable measure of the parallax optimization (e.g., a low parallax volume 188) of a lens system designed for the current panoramic capture devices and applications. As will also be seen, the design of an improved device (300) can be optimized to position the geometric center of the device, or device center 196, outside, but proximate to this low parallax volume 188, or alternately within it, and preferably proximate to a non-paraxial chief ray NP point.

As one aspect, FIG. 5A depicts the projection of the theoretical edge of the fields of view (FOV edges 155), past the outer lens elements (lenses 175 and 180) of two adjacent cameras, to provide lines directed to a common point (190). These lines represent theoretical limits of the complex “conical” opto-mechanical lens assemblies, which typically are pentagonally conical or hexagonally conical limiting volumes. Again, ideally, in a no-parallax multi-camera system, the entrance pupils or NP points of two adjacent cameras are co-located. But to avoid mechanical conflicts, the mechanics of a given lens assembly, including the sensor package, should generally not protrude outside a frustum of a camera system and into the conical space of an adjacent lens assembly. However, real lens assemblies in a multi-camera panoramic capture device are also separated by seams 160. Thus, the real chief rays 170 that are accepted at the lens edges, which are inside of both the mechanical seams and a physical width or clear aperture of a mounted outer lens element (lenses 175 and 180), when projected generally towards a paraxial NP point 190, can land instead at offset NP points 192, and be separated by an NP point offset distance 194.

This can be better understood by considering the expanded area A-A in proximity to a nominal or ideal point NP 190, as shown in detail in FIG. 5B. Within a hexagonal FOV 182, light rays that propagate within the Gauss or paraxial region (e.g., paraxial ray 173), and that pass through the nominal center of the aperture stop, can be projected to a nominal NP point 190 (corresponding to the entrance pupil), or to an offset NP point 190A at a small NP point difference or offset 193 from a nominal NP point 190. Whereas, the real hexagonal lens edge chief rays 170 associated with a maximum inscribed circle within a hexagon, can project to land at a common offset NP point 192A that can be at a larger offset distance (194A). The two adjacent cameras in FIGS. 5A,B also may or may not share coincident NP points (e.g., 190). Distance offsets can occur due to various reasons, including geometrical concerns between cameras (adjacent hexagonal and pentagonal cameras), geometrical asymmetries within a camera (e.g., for a pentagonal camera), or from limitations from the practical widths of seams 160, or because of the directionality difference amongst aberrated rays.

As just noted, there are also potential geometric differences in the projection of incident chief rays towards a simplistic nominal “NP point” (190). First, incident imaging light paths from near the corners or vertices or mid-edges (mid-chords) of the hexagonal or pentagonal lenses may or may not project to common NP points within the described range between the nominal paraxial NP point 190 and an offset NP point 192B. Also, as shown in FIG. 5B, just from the geometric asymmetry of the pentagonal lenses, the associated pair of edge chief rays 170 and 171 for the real accepted FOV, can project to different nominal NP points 192B that can be separated from both a paraxial NP point (190) by an offset distance 194B and from each other by an offset distance 194C.

As another issue, during lens design, the best performance typically occurs on axis, or near on axis (e.g., ≤0.3 field (normalized)), near the optical axis 185. In many lenses, good imaging performance, by design, often occurs at or near the field edges, where optimization weighting is often used to force compliance. The worst imaging performance can then occur at intermediate fields (e.g., 0.7-0.8 of a normalized image field height). Considering again FIG. 5A,B, intermediate off axis rays, from intermediate fields (θ) outside the paraxial region, but not as extreme as the edge chief rays (10°<θ<20.9°, can project towards intermediate NP points between a nominal NP point 190 and an offset NP point 192B. But other, more extreme off axis rays, particularly from the 0.7-0.8 intermediate fields, that are more affected by aberrations, can project to NP points at locations that are more or less offset from the nominal NP point 190 than are the edge of field offset NP points 192B. Accounting for the variations in lens design, the non-paraxial offset “NP” points can fall either before (closer to the lens) the paraxial NP point (the entrance pupil) as suggested in FIG. 5B, or after it (as shown in FIG. 2A).

This is shown in greater detail in FIG. 5C, which essentially illustrates a further zoomed-in region A-A of FIG. 5B, but which illustrates an impact from vectoral projected ray paths associated with aberrated image rays, that converge at and near the paraxial entrance pupil (190), for an imaging lens system that was designed and optimized using the methods of the present approach. In FIG. 5C, the projected ray paths of green aberrated image rays at multiple fields from a camera lens system converge within a low parallax volume 188 near one or more “NP” points. Similar illustrations of ray fans can also be generated for Red or Blue light. The projection of paraxial rays 173 can converge at or near a nominal paraxial NP point 190, or entrance pupil, located on a nominal optical axis 185 at a distance Z behind the image plane 150. The projection of edge of field rays 172, including chief rays 171, converge at or near an offset NP point 192B along the optical axis 185. The NP point 192B can be quantitatively defined, for example, as the center of mass of all edge of field rays 172. An alternate offset NP point 192A can be identified, that corresponds to a “circle of least confusion”, where the paraxial, edge, and intermediate or mid-field rays, aggregate to the smallest spot. These different “NP” points are separated from the paraxial NP point by offset distances 194A and 194B, and from each other by an offset distance 194C. Thus, it can be understood that an aggregate “NP point” for any given real imaging lens assembly or camera lens that supports a larger than paraxial FOV, or an asymmetrical FOV, is typically not a point, but instead can be an offset low parallax (LP) smudge or volume 188.

Within a smudge or low parallax volume 188, a variety of possible optimal or preferred NP points can be identified. For example, an offset NP point corresponding to the edge of field rays 172 can be emphasized, so as to help provide improved image tiling. An alternate mid-field (e.g., 0.6-0.8) NP point (not shown) can also be tracked and optimized for. Also the size and position of the overall “LP” smudge or volume 188, or a preferred NP point (e.g., 192B) therein, can change depending on the lens design optimization. Such parameters can also vary amongst lenses, for one fabricated lens system of a given design to another, due to manufacturing differences amongst lens assemblies. Although FIG. 5C depicts these alternate offset “NP points” 192A,B for non-paraxial rays as being located after the paraxial NP point 190, or further away from the lens and image plane, other lenses of this type, optimized using the methods of the present approach, can be provided where similar non-paraxial NP points 192A,B that are located with a low parallax volume 188 can occur at positions between the image plane and the paraxial NP point.

FIG. 5C also shows a location for a center of the low-parallax multi-camera panoramic capture device, device center 196. Based on optical considerations, an improved panoramic multi-camera capture device 300 can be preferably optimized to nominally position the device center 196 within the low parallax volume 188. Optimized locations therein can include being located at or proximate either of the offset NP points 192A or 192B, or within the offset distance 194B between them, so as to prioritize parallax control for the edge of field chief rays. The actual position therein depends on parallax optimization, which can be determined by the lens optimization relative to spherical aberration of the entrance pupil, or direct chief ray constraints, or distortion, or a combination thereof. For example, whether the spherical aberration is optimized to be over corrected or under corrected, and how weightings on the field operands in the merit function are used, can affect the positioning of non-paraxial “NP” points for peripheral fields or mid fields. The “NP” point positioning can also depend on the management of fabrication tolerances and the residual variations in lens system fabrication. The device center 196 can also be located proximate to, but offset from the low parallax volume 188, by a center offset distance 198. This approach can also help tolerance management and provide more space near the device center 196 for cables, circuitry, cooling hardware, and the associated structures. In such case, the adjacent cameras 120 can then have offset low parallax volumes 188 of “NP” points (FIG. 5D), instead of coincident ones (FIGS. 5A, B). In this example, if the device center 196 is instead located at or proximate to the paraxial entrance pupil, NP point 190, then effectively one or more of the outer lens elements 137 of the cameras 120 are undersized and the desired full FOVs are not achievable.

Thus, while the no-parallax (NP) point is a useful concept to work towards, and which can valuably inform panoramic image capture and systems design, and aid the design of low-parallax error lenses, it is idealized, and its limitations must also be understood. Considering this discussion of the NP point(s) and LP smudges, in enabling an improved low-parallax multi-camera panoramic capture device, it is important to understand ray behavior in this regime, and to define appropriate parameters or operands to optimize, and appropriate target levels of performance to aim for. In the latter case, for example, a low parallax lens with a track length of 65-70 mm can be designed for in which the LP smudge is as much as 10 mm wide (e.g., offset distance 194A). But alternate lens designs, for which this parameter is further improved, can have a low parallax volume 188 with a longitudinal LP smudge width or width along the optical axis (offset 194A) of a few millimeters or less.

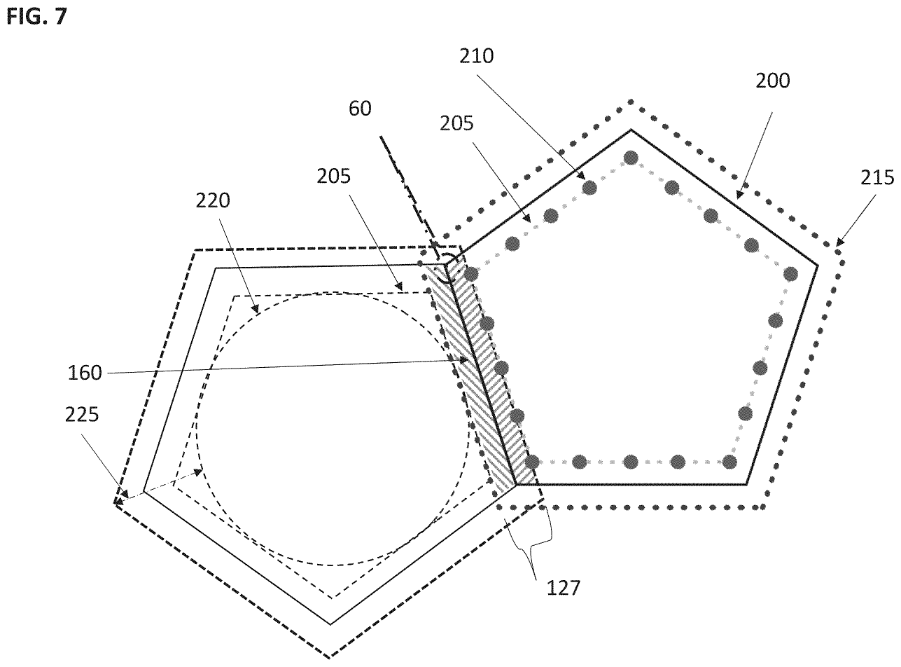

The width and location of the low parallax volume 188, and the vectoral directions of the projections of the various chief rays, and their NP point locations within a low parallax volume, can be controlled during lens optimization by a method using operands associated with a fan of chief rays 170 (e.g., FIGS. 2A,B). But the LP smudge or LP volume 188 of FIG. 5C can also be understood as being a visualization of the transverse component of spherical aberration of the entrance pupil, and this parameter can be used in an alternate, but equivalent, design optimization method to using chief ray fans. In particular, during lens optimization, using Code V for example, the lens designer can create a special user defined function or operand for the transverse component (e.g., ray height) of spherical aberration of the entrance pupil, which can then be used in a variety of ways. For example, an operand value can be calculated as a residual sum of squares (RSS) of values across the whole FOV or across a localized field, using either uniform or non-uniform weightings on the field operands. In the latter case of localized field preferences, the values can be calculated for a location at or near the entrance pupil, or elsewhere within a low parallax volume 188, depending on the preference towards paraxial, mid, or peripheral fields. An equivalent operand can be a width of a circle of least confusion in a plane, such as the plane of offset NP point 192A or that of offset NP 192B, as shown in FIG. 5C. The optimization operand can also be calculated with a weighting to reduce or limit parallax error non-uniformly across fields, with a disproportionate weighting favoring peripheral or edge fields over mid-fields. Alternately, the optimization operand can be calculated with a weighting to provide a nominally low parallax error in a nominally uniform manner across all fields (e.g., within or across a Core FOV 205, as in FIG. 7). That type of optimization may be particularly useful for mapping type applications.

Whether the low-parallax lens design and optimization method uses operands based on chief rays or spherical aberration of the entrance pupil, the resulting data can also be analyzed relative to changes in imaging perspective. In particular, parallax errors versus field and color can also be analyzed using calculations of the Center of Perspective (COP), which is a parameter that is more directly relatable to visible image artifacts than is a low parallax volume, and which can be evaluated in image pixel errors or differences for imaging objects at two different distances from a camera system. The center of perspective error is essentially the change in a chief ray trajectory given multiple object distances—such as for an object at a close distance (3 ft), versus another at “infinity.”

In drawings and architecture, perspective, is the art of drawing solid objects on a two-dimensional surface so as to give a correct impression of their height, width, depth, and position in relation to each other when viewed from a particular point. For example, for illustrations with linear or point perspective, objects appear smaller as their distance from the observer increases. Such illustrated objects are also subject to foreshortening, meaning that an object's dimensions along the line of sight appear shorter than its dimensions across the line of sight. Perspective works by representing the light that passes from a scene through an imaginary rectangle (realized as the plane of the illustration), to a viewer's eye, as if the viewer were looking through a window and painting what is seen directly onto the windowpane.

Perspective is related to both parallax and stereo perception. In a stereoscopic image capture or projection, with a pair of adjacent optical systems, perspective is a visual cue, along with dual view parallax, shadowing, and occlusion, that can provide a sense of depth. As noted previously, parallax is the visual perception that the position or direction of an object appears to be different when viewed from different positions. In the case of image capture by a pair of adjacent cameras with at least partially overlapping fields of view, parallax image differences are a cue for stereo image perception, or are an error for panoramic image assembly.

To capture images with an optical system, whether a camera or the human eye, the optical system geometry and performance impacts the utility of the resulting images for low parallax (panoramic) or high parallax (stereo) perception. In particular, for an ideal lens, all the chief rays from object space point exactly towards the center of the entrance pupil, and the entrance pupil is coincident with the center of perspective (COP) or viewpoint center for the resulting images. There are no errors in perspective or parallax for such an ideal lens.

But for a real lens, having both physical and image quality limitations, residual parallax errors can exist. As stated previously, for a real lens, a projection of the paraxial chief rays from the first lens element, will point towards a common point, the entrance pupil, and its location can be determined as an axial distance from the front surface of that first element. Whereas, for a real lens capturing a FOV large enough to include non-paraxial chief rays, the chief rays in object space can point towards a common location or volume near, but typically offset from, the center of the entrance pupil. These chief rays do not intrinsically coincide at a single point, but they can be directed through a small low parallax volume 188 (e.g., the LP “smudge”) by appropriate lens optimization. The longitudinal or axial variation of rays within the LP smudge can be determined from the position a chief ray crosses the optic axis. The ray errors can also be measured as a transverse width or axial position of the chief rays within an LP smudge.

The concept of parallax correction, with respect to centers of perspective, is illustrated in FIG. 5D. A first camera lens 120A collects and images light from object space 105 into at least a Core FOV, including light from two outer ray fans 179A and 179B, whose chief ray projections converge towards a low parallax volume 188A. These ray fans can correspond to a group of near edge or edge of field rays 172, as seen in FIG. 2B or FIG. 5C. As was shown in FIG. 5C, within an LP volume 188, the vectoral projection of such rays from object space, generally towards image space, can cross the optical axis 185 beyond the image plane, at or near an alternate NP point 192B that can be selected or preferred because it favors edge of field rays. However, as is also shown in FIG. 5C, such edge of field rays 172 need not cross the optical axis 185 at exactly the same point. Those differences, when translated back to object space 105, translate into small differences in the parallax or perspective for imaged ray bundles or fans within or across an imaged FOV (e.g., a Core FOV 205, as in FIG. 7) of a camera lens.

A second, adjacent camera lens 120B, shown in FIG. 5D, can provide a similar performance, and image a fan of chief rays 170, including ray fan 179C, from within a Core FOV 205 with a vectoral projection of these chief rays converging within a corresponding low parallax volume 188B. LP volumes 188A and 188B can overlap or be coincident, or be offset, depending on factors including the camera geometries and the seams between adjacent cameras, or lens system fabrication tolerances and compensators, or on whether the device center 196 is offset from the LP volumes 188. The more overlapped or coincident these LP volumes 188 are, the more overlapped are the centers of perspective of the two lens systems. Ray Fan 179B of camera lens 120A and ray fan 179C of camera lens 120B are also nominally parallel to each other; e.g., there is no parallax error between them. However, even if the lens designs allow very little residual parallax errors at the FOV edges, fabrication variations between lens systems can increase the differences.

Analytically, the chief ray data from a real lens can also be expressed in terms of perspective error, including chromatic errors, as a function of field angle. Perspective error can then be analyzed as a position error at the image between two objects located at different distances or directions. Perspective errors can depend on the choice of COP location, the angle within the imaged FOV, and chromatic errors. For example, it can be useful to prioritize a COP so as to minimize green perspective errors. Perspective differences or parallax errors can be reduced by optimizing a chromatic axial position (Δz) or width within an LP volume 188 related to a center of perspective for one or more field angles within an imaged FOV. The center of perspective can also be graphed and analyzed as a family of curves, per color, of the Z (axial) intercept position (distance in mm) versus field angle. Alternately, to get a better idea of what a captured image will look like, the COP can be graphed and analyzed as a family of curves for a camera system, as a parallax error in image pixels, per color, versus field.

During the design or a camera lens systems, a goal can be to limit the parallax error to a few pixels or less for imaging within a Core FOV 205 (FIG. 7). Alternately, it can be preferable to particularly limit parallax errors in the peripheral fields, e.g., for the outer edges of a Core FOV and for an Extended FOV region (if provided). If the residual parallax errors for a camera are thus sufficiently small, then the parallax differences seen as a perspective error between two adjacent cameras near their shared seam 160, or within a seam related region of extended FOV overlap imaging, can likewise be limited to several pixels or less (e.g., ≤3-4 pixels). Depending on the lens design, device design, and application, it can be possible and preferable to reduce parallax errors for a lens system further, as measured by perspective error, to ≤0.5 pixel for an entire Core FOV, the peripheral fields, or both. If these residual parallax errors for each of two adjacent cameras are small enough, images can be acquired, cropped, and readily tiled, while compensating for or hiding image artifacts from any residual seams 160 or blind regions 165.

In pursuing the design of a panoramic camera of the type of that of FIG. 1, but to enable an improved low-parallax multi-camera panoramic capture device (300), having multiple adjacent cameras, the choices of lens optimization methods and parameters can be important. A camera lens 120, or system of lens elements 135, like that of FIG. 2A, can be used as a starting point. The camera lens has compressor lens element(s), and inner lens elements 140, the latter of which can also be defined as consisting of a pre-stop wide angle lens group, and a post-stop eyepiece-like lens group. In designing such lenses to reduce parallax errors, it can be valuable to consider how a fan of paraxial to non-paraxial chief rays 125 (see FIG. 2A), or a fan of edge chief rays 170 (see FIG. 2B), or localized collections of edge of field rays 172 (see FIG. 5C) or 179 A,B (see FIG. 5D) are imaged by a camera lens assembly. It is possible to optimize the lens design by using a set of merit function operands for a collection or set (e.g., 31 defined rays) of chief rays, but the optimization process can then become cumbersome. As an alternative, in pursuing the design of an improved low-parallax multi-camera panoramic capture device (300), it was determined that improved performance can also be obtained by using a reduced set of ray parameters or operands that emphasizes the transverse component of spherical aberration at the entrance pupil, or at a similar selected surface or location (e.g., at an offset NP point 192A or 192B) within an LP smudge volume 188 behind the lens system. Optimization for a transverse component of spherical aberration at an alternate non-paraxial entrance pupil can be accomplished by using merit function weightings that emphasize the non-paraxial chief rays.

As another aspect, in a low-parallax multi-camera panoramic capture device, the fans of chief rays 170 that are incident at or near a beveled edge of an outer lens element of a camera 120 (see FIG. 2B) should be parallel to a fan of chief rays 170 that are incident at or near an edge 132 of a beveled surface of the outer lens element of an adjacent camera (see FIG. 1). It is noted that an “edge” of an outer lens element 137 or compressor lens is a 3-dimensional structure (see FIG. 2B), that can have a flat edge cut through a glass thickness, and which is subject to fabrication tolerances of that lens element, the entire lens assembly, and housing 130, and the adjacent seam 160 and its structures. The positional definition of where the beveled edges are cut into the outer lens element depends on factors including the material properties, front color, distortion, parallax correction, tolerances, and an extent of any extra extended FOV 215. An outer lens element 137 becomes a faceted outer lens element when beveled edges 132 are cut into the lens, creating a set of polygonal shaped edges that nominally follow a polygonal pattern (e.g., pentagonal or hexagonal).

A camera system 120 having an outer lens element with a polygonal shape that captures incident light from a polygonal shaped field of view can then form a polygonal shaped image at the image plane 150, wherein the shape of the captured polygonal field of view nominally matches the shape of the polygonal outer lens element. The cut of these beveled edges for a given pair of adjacent cameras can affect both imaging and the optomechanical construction at or near the intervening seam 160.

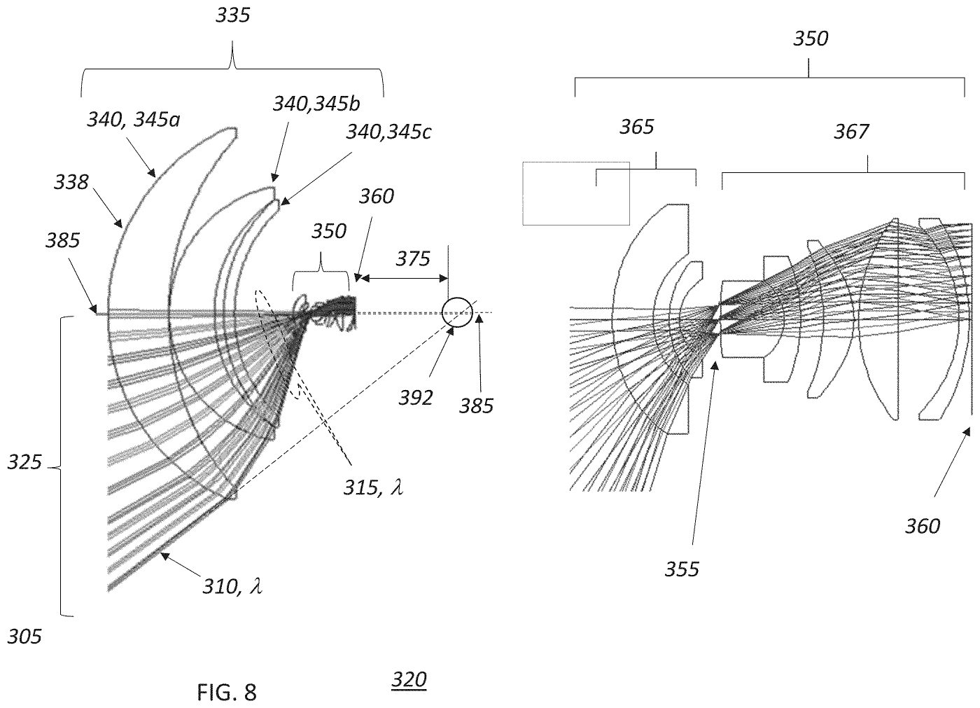

As another aspect, FIG. 5E depicts “front color”, which is a difference in the nominal ray paths by color versus field, as directed to an off axis or edge field point. Typically, for a given field point, the blue light rays are the furthest offset. As shown in FIG. 5E, the accepted blue ray 157 on a first lens element 137 is ΔX≈1 mm further out than the accepted red ray 158 directed to the same image field point. If the lens element 137 is not large enough, then this blue light can be clipped or vignetted and a color shading artifact can occur at or near the edges of the imaged field. Front color can appear in captured image content as a narrow rainbow-like outline of the polygonal FOV or the polygonal edge of an outer compressor lens element (e.g., FIG. 8) which acts as a field stop for the optical system. Localized color transmission differences that can cause front color related color shading artifacts near the image edges can be caused by differential vignetting at the beveled edges of the outer compressor lens element 137, or from edge truncation at compressor lens elements, or through the aperture stop 145. During lens design optimization to provide an improved camera lens (320), front color can be reduced (e.g., to □X(B-R)≤0.5 mm width) as part of the chromatic correction of the lens design, including by glass selection within the compressor lens group or the entire lens design, or as a trade-off in the correction of lateral color. The effect of front color on captured images can also be reduced optomechanically, by designing an improved camera lens (320) to have an extended FOV 215 (FIG. 7), and also the opto-mechanics to push straight cut or beveled lens edges 132 at or beyond the edge of the extended FOV 215, so that any residual front color occurs outside the core FOV 220. The front color artifact can then be eliminated during an image cropping step during image processing. The impact of front color or lateral color can also be reduced by a spatially variant color correction during image processing. As another option, an improved camera lens (320) can have a color dependent aperture at or near the aperture stop, that can, for example, provide a larger transmission aperture (diameter) for blue light than for red or green light.

FIG. 5F depicts a variation of center of perspective 280, as an error or difference in image pixels versus field angle and color (R, G, B) for a low-parallax lens of the type of FIGS. 2A and 2B, but with an improved optical design and performance. In this example, imaging of two objects, one at a 3-foot distance from an improved low-parallax multi-camera panoramic capture device (300) having improved low-parallax camera lenses 320 and the other object at an “infinite” (∞) distance from the device, were analyzed. FIG. 5F shows parallax errors of <1 pixel for all colors, from on axis, to nearly the edge of the field (e.g., to ˜34 deg.). Parallax errors can also be quantified in angles (e.g., fractions of a degree per color). Although the R,G,B curves of center of perspective difference 280 have similar shapes due to parallax optimization, there are small offset and slope differences between them. These differences are expressions of residual chromatic differences in the lens, including lateral color, axial color, and front color. The parallax errors for blue light exceed 1.5 pixels out at the extreme field points (e.g., the vertices). However, most visible imaging systems, including the human visual system, and cameras using Bayer type color filter arrays, are desensitized to resolution type errors when imaging in blue light, relative to imaging red and green light. In general, providing parallax errors of ≤2 pixels from a camera, within its core FOV 205, and particularly the peripheral fields thereof, and preferably also within a modest sized extended FOV 215, can limit residual image artifacts to acceptable and hard to detect levels. But limiting perspective or parallax errors further, to sub-pixel levels (e.g., ≤0.5 pixel) for imaging within these FOVs, and particularly within the peripheral fields, for at least green light, is preferable. If the residual parallax errors between adjacent cameras are small enough, the captured images obtained from the core FOVs can be readily and quickly cropped and tiled together. Likewise, if the residual parallax errors within the extended FOVs that capture content in or near the seams are similarly small enough, and the two adjacent cameras are appropriately aligned to one another, then the overlapped captured image content by the two cameras can be quickly cropped or averaged and included in the output panoramic images.

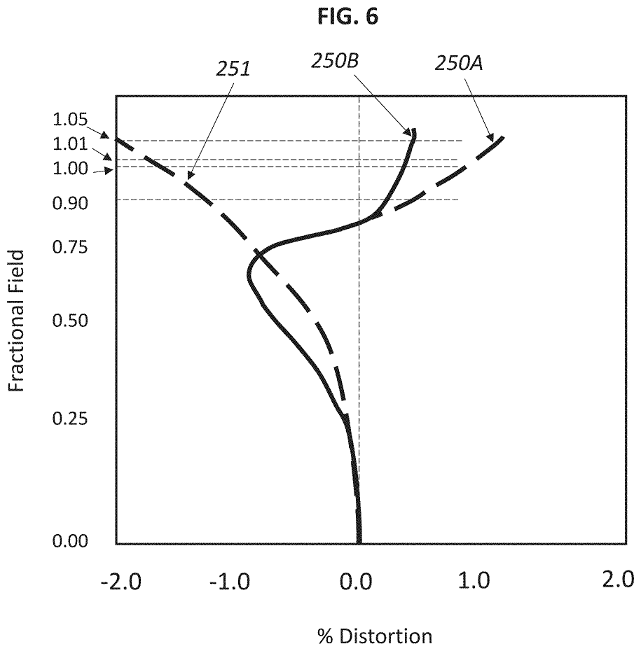

Optical performance at or near the seams can also be understood, in part, relative to distortion (FIG. 6) and a set of defined fields of view (FIG. 7). In particular, FIG. 7 depicts potential sets of fields of view for which potential image light can be collected by two adjacent cameras. As an example, a camera with a pentagonally shaped outer lens element, whether associated with a dodecahedron or truncated icosahedron or other polygonal lens camera assembly, with a seam 160 separating it from an adjacent lens or camera channel, can image an ideal FOV 200 that extends out to the vertices (60) or to the polygonal edges of the frustum or conical volume that the lens resides in. However, because of the various physical limitations that can occur at the seams, including the finite thicknesses of the lens housings, the physical aspects of the beveled lens element edges, mechanical wedge, and tolerances, a smaller core FOV 205 of transiting image light can actually be imaged. The coated clear aperture for the outer lens elements 137 should encompass at least the core FOV 205 with some margin (e.g., 0.5-1.0 mm). As the lens can be fabricated with AR coatings before beveling, the coatings can extend out to the seams. The core FOV 205 can be defined as the largest low parallax field of view that a given real camera 120 can image. Equivalently, the core FOV 205 can be defined as the sub-FOV of a camera channel whose boundaries are nominally parallel to the boundaries of its polygonal cone (see FIGS. 5A and 5B). Ideally, with small seams 160, and proper control and calibration of FOV pointing, the nominal Core FOV 205 approaches or matches the ideal FOV 200 in size.

During a camera alignment and calibration process, a series of image fiducials 210 can be established along one or more of the edges of a core FOV 205 to aid with image processing and image tiling or mosaicing. The resulting gap between a core FOV 205 supported by a first camera and that supported by an adjacent camera can result in blind regions 165 (FIG. 5A, B). To compensate for the blind regions 165, and the associated loss of image content from a scene, the cameras can be designed to support an extended FOV 215, which can provide enough extra FOV to account for the seam width and tolerances, or an offset device center 196. As shown in FIG. 7, the extended FOV 215 can extend far enough to provide overlap 127 with an edge of the core FOV 205 of an adjacent camera, although the extended FOVs 215 can be larger yet. This limited image overlap can result in a modest amount of image resolution loss, parallax errors, and some complications in image processing as were previously discussed with respect to FIG. 3, but it can also help reduce the apparent width of seams and blind regions. However, if the extra overlap FOV is modest (e.g., ≤5%) and the residual parallax errors therein are small enough (e.g. ≤0.75 pixel perspective error), as provided by the present approach, then the image processing burden can be very modest. Image capture out to an extended FOV 215 can also be used to enable an interim capture step that supports camera calibration and image corrections during the operation of an improved panoramic multi-camera capture device 300. FIG. 7 also shows an inscribed circle within one of the FOV sets, corresponding to a subset of the core FOV 205, that is the common core FOV 220 that can be captured in all directions from that camera. The angular width of the common core FOV 220 can be useful as a quick reference for the image capacity of a camera. An alternate definition of the common core FOV 220 that is larger, to include the entire core FOV 205, can also be useful. The dashed line (225) extending from the common core FOV 220 or core FOV 205, to beyond the ideal FOV 200, to nominally include the extended FOV 215, represents a region in which the lens design can support careful mapping of the chief or principal rays or control of spherical aberration of the entrance pupil, so as to enable low-parallax error imaging and easy tiling of images captured by adjacent cameras.

Across a seam 160 spanning the distance between two adjacent usable clear apertures between two adjacent cameras, to reduce parallax and improve image tiling, it can be advantageous if the image light is captured with substantial straightness, parallelism, and common spacing over a finite distance. The amount of FOV overlap needed to provide an extended FOV and limit blind regions can be determined by controlling the relative proximity of the entrance pupil (paraxial NP point) or an alternate preferred plane within a low parallax volume 188 (e.g., to emphasize peripheral rays) to the device center 196 (e.g., to the center of a dodecahedral shape). The amount of Extended FOV 215 is preferably 5% or less (e.g., ≤1.8° additional field for a nominal Core FOV of 37.5°), such that a camera's peripheral fields are then, for example, ˜0.85-1.05). If spacing constraints at the device center, and fabrication tolerances, are well managed, the extended FOV 215 can be reduced to ≤1% additional field. Within an extended FOV 215, parallax should be limited to the nominal system levels, while both image resolution and relative illumination remain satisfactory. The parallax optimization to reduce parallax errors can use either chief ray or pupil aberration constraints, and targeting optimization for a high FOV region (e.g., 0.85-1.0 field), or beyond that to include the extra camera overlap regions provided by an extended FOV 215 (e.g., FIG. 7, a fractional field range of ˜0.85-1.05).

In addition, in enabling an improved low-parallax multi-camera panoramic capture device (300), with limited parallax error and improved image tiling, it can be valuable to control image distortion for image light transiting at or near the edges of the FOV, e.g., the peripheral fields, of the outer lens element. In geometrical optics, distortion is a deviation from a preferred condition (e.g., rectilinear projection) that straight lines in a scene remain straight in an image. It is a form of optical aberration, which describes how the light rays from a scene are mapped to the image plane. In general, in lens assemblies used for image capture, for human viewing it is advantageous to limit image distortion to a maximum of +/−2%. In the current application, for tiling or combining panoramic images from images captured by adjacent cameras, having a modest distortion of ≤2% can also be useful. As a reference, in barrel distortion, the image magnification decreases with distance from the optical axis, and the apparent effect is that of an image which has been mapped around a sphere (or barrel). Fisheye lenses, which are often used to take hemispherical or panoramic views, typically have this type of distortion, as a way to map an infinitely wide object plane into a finite image area. Fisheye lens distortion (251) can be large (e.g., 15% at full field or 90° half width (HW)), as a deviation from f-theta distortion, although it is only a few percent for small fields (e.g., ≤30° HW). As another example, in laser printing or scanning systems, f-theta imaging lenses are often used to print images with minimal banding artifacts and image processing corrections for pixel placement. In particular, F-theta lenses are designed with a barrel distortion that yields a nearly constant spot or pixel size, and a pixel positioning that is linear with field angle θ, (h=f*θ).

Thus, improved low-parallax cameras 320 that capture half FOVs of ≤35-40° might have fisheye distortion 251, as the distortion may be low enough. However, distortion can be optimized more advantageously for the design of improved camera lens assemblies for use in improved low-parallax multi-camera panoramic capture devices (300). As a first example, as shown in FIG. 6, it can be advantageous to provide camera lens assemblies with a localized nominal f-theta distortion 250A at or near the edge of the imaged field. In an example, the image distortion 250 peaks at ˜0.75 field at about 1%, and the lens design is not optimized to provide f-theta distortion 250 below ˜0.85 field. However, during the lens design process, a merit function can be constrained to provide a nominally f-theta like distortion 250A or an approximately flat distortion 250B, for the imaged rays at or near the edge of the field, such as for peripheral fields spanning a fractional field range of ˜0.9-1.0. This range of high fields with f-theta type or flattened distortion correction includes the fans of chief rays 170 or perimeter rays of FIG. 2B, including rays imaged through the corners or vertices 60, such as those of a lens assembly with a hexagonal or pentagonal outer lens element 137. Additionally, because of manufacturing tolerances and dynamic influences (e.g., temperature changes) that can apply to a camera 120, including both lens elements 135 and a housing 130, and to a collection of cameras 120 in a panoramic multi-camera capture device, it can be advantageous to extend the region of nominal f-theta or flattened distortion correction in peripheral fields to beyond the nominal full field (e.g., 0.85-1.05). This is shown in FIG. 6, where a region of reduced or flattened distortion extends beyond full field to ˜1.05 field. In such a peripheral field range, it can be advantageous to limit the total distortion variation to ≤0.5% or less. Controlling peripheral field distortion keeps the image “edges” straight in the adjacent pentagonal shaped regions. This can allow more efficient use of pixels when tiling images, and thus faster image processing.

The prior discussion treats distortion in a classical sense, as an image aberration at an image plane. However, in low-parallax cameras, this residual distortion is typically a tradeoff or nominal cancelation of contributions from the compressor lens elements (137) versus those of the aggregate inner lens elements (140). Importantly, the ray re-direction caused by the distortion contribution of the outer compressor lens element also affects both the imaged ray paths and the projected chief ray paths towards the low parallax volume. This in turn means that for the design of at least some low-parallax lenses, distortion optimization can affect parallax or edge of field NP point or center of perspective optimization.

The definitions of the peripheral fields or a fractional field range 225 of (e.g., ˜0.85-1.05, or including ≤5% extra field), in which parallax, distortion, relative illumination, resolution, and other performance factors can be carefully optimized to aid image tiling, can depend on the device and camera geometries. As an example, for hexagonal shaped lenses and fields, the lower end of the peripheral fields can be defined as ˜0.83, and for pentagonal lenses, ˜0.8. Although FIG. 7 was illustrated for a case with two adjacent pentagon-shaped outer lens elements and FOV sets, the approach of defining peripheral fields and Extended FOVs to support a small region of overlapped image capture, can be applied to multi-camera capture device designs with adjacent pentagonal and hexagonal cameras, or to adjacent hexagonal cameras, or to cameras with other polygonal shapes or with adjacent edges of any shape or contour generally.

For an Extended FOV 215 to be functionally useful, the nominal image formed onto an image sensor that corresponds to a core FOV 205 needs to underfill the used image area of the image sensor, by at least enough to allow an extended FOV 215 to also be imaged. This can be done to help account for real variations in fabricated lens assemblies from the ideal, or for the design having an offset device center 196, as well as fabrication variations in assembling an improved low-parallax multi-camera panoramic capture device (300). But as is subsequently discussed, prudent mechanical design of the lens assemblies can impact both the imaged field of view of a given camera and the seams between the cameras, to limit mechanical displacements or wedge and help reduce parallax errors and FOV overlap or underlap. Likewise, tuning the image FOV (core FOV 205) size and position with compensators or with fiducials and image centroid tracking and shape tracking can help. Taken together in some combination, optimization of distortion and low or zero parallax imaging over extended peripheral fields, careful mechanical design to limit and compensate for component and assembly variations, and the use of corrective fiducials or compensators, can provide a superior overall systems solution. As a result, a captured image from a camera can readily be cropped down to the nominal size and shape expected for the nominal core FOV 205, and images from multiple cameras can then be mosaiced or tiled together to form a panoramic image, with reduced burdens on image post-processing. However, an extended FOV 215, if needed, should provide enough extra angular width (e.g., θ₁≤5% of the FOV) to match or exceed the expected wedge or tilt angle □₂, that can occur in the seams, θ₁≥θ₂.

In designing an improved imaging lens of the type that can be used in a low-parallax panoramic multi-camera capture device (100 or 300), several first order parameters can be calculated so as to inform the design effort. A key parameter is the target size of the frustum or conical volume, based on the chosen polygonal configuration (lens size (FOV) and lens shape (e.g., pentagonal)) and the sensor package size. Other key parameters that can be estimated include the nominal location of the paraxial entrance pupil, the focal lengths of the compressor lens group and the wide-angle lens group, and the FOV seen by the wide-angle group.

But the design optimization for an improved camera lens (320) for use in an improved low-parallax panoramic multi-camera capture devices (300) also depends on how the numerous other lens attributes and performance metrics are prioritized. In particular, the relevant system parameters can include the control of parallax or the center of perspective (COP) error at the edges of an imaged field or for inner field locations or both, as optimized using fans of chief rays or spherical aberration of the entrance pupil). These parameters are closely linked with other key parameters including the width and positions of the “LP smudge” or volume 188, the size of any center offset distance between the entrance pupil or LP smudge and the device center 196, the target width of the gaps or seams, the extent of blind regions 165, and the size of any marginal or extended FOV to provide overlap. The relevant performance metrics can include image resolution or MTF, distortion (particularly in the peripheral fields, and distortion of the first compressor lens element and of the compressor lens group), lateral color, relative illumination, front color, and color vignetting, telecentricity, and ghosting. Other relevant design variables can include mechanical and materials parameters such as the number of compressor lens elements, the configuration of the compressor lens group, the wide-angle lens group and eyepiece lens group, glass choices, the allowed maximum size of the first compressor or outer lens element, the sensor package size, the track length, the nominal distance from the image plane to the nearest prior lens element (e.g., working distance), the nominal distance from the image plane to the entrance pupil, the nominal distance from the image plane or the entrance pupil to the polygonal center or device center, manufacturing tolerances and limits, and the use of compensators.

As a second illustrative example, FIG. 8 depicts an alternate improved camera lens 320 or objective lens with lens elements 335, that is an enhanced version of the lens 120 of FIG. 2A that can be used in an improved low-parallax multi-camera panoramic capture device (300). FIG. 8 illustrates the overall lens form on the left, and a zoomed in portion that illustrates the inner lens elements 350 in greater detail. This lens, which is also designed for a dodecahedral system, has lens elements 335 that includes both a first lens element group or compressor lens group consisting of outer lens element 345a and compressor lens elements 345b and 345c, and inner lens elements 350. In this design, compressor elements 345b,c are not quite combined as a cemented or air space doublet. As also shown in FIG. 8, inner lens elements 350 consists of a front wide-angle lens group 365 and a rear eyepiece like lens group 367.

In FIG. 8, the lens system of camera 320 collects light rays 310 from object space 305 to provide image light 315 from a field of view 325, and directs them through lens elements 335, which consist of outer lens elements 340 and inner lens elements 350, to provide an image at an image plane 360. This lens system provides improved image quality, telecentricity, and parallax control, although these improvements are not obvious in FIG. 8. In this example, the outer lens elements 340 comprise a group of three compressor lens elements 345a, 345b, and 345c, and the optical power, or light bending burden, is shared amongst the multiple outer lens elements. Image light 310 from object space 305 is refracted and transmitted through a first lens element group or compressor lens group 340 having three lens elements, such that chief rays at 37.377 deg. at the vertices are redirected at a steep angle of ˜80 deg. towards the optical axis 385.

This compressor lens element group is followed by a second lens element group or wide-angle lens element group 365, which consists of the two lens elements between the compressor lens element group and the aperture stop 355. A third lens element group or eyepiece lens group 367, which has five lens elements, redirects the transiting image light coming from the aperture stop 355 to provide image light telecentrically at F/2.8 to an image sensor at an image plane 360. As this lens is designed for a dodecahedral system, the first lens element 345a nominally accepts image light for a FOV width of 31.717 deg. at the mid-chords. The chief ray projections converge or point towards an LP smudge 392 which includes a paraxially defined entrance pupil.

Although this type of camera lens, or lens form, as exemplified by FIG. 8, with a first lens element group or compressor lens group or lens element (345a,b,c), a pre-stop second lens element group or wide angle lens group 365, and a post-stop third lens element group or eyepiece-like lens group 367, may in entirety, or in part, visually resemble a fisheye lens, it is quite different. Unlike the present lens design (e.g., FIG. 8A), a fisheye lens is an ultra-wide-angle lens that has heavily overcorrected spherical aberration of the pupil such that its entrance pupil is positioned near the front of the lens, in proximity to the first lens element. This pupil aberration also causes substantial shifts and rotations for the non-paraxial entrance pupils relative to the paraxial one. Such a lens is also reverse telephoto to provide a long back focal length, and a positive value for a ratio of the entrance pupil to image plane distance (EPID), divided by the lens focal length (EPID/EFL). A fisheye lens also provides a strong visual distortion that typically follows a monotonic curve (e.g., H=fθ (f-theta)), that images with a characteristic convex non-rectilinear appearance. The typical fisheye lens captures a nominal 180° wide full FOV, although fisheye lenses that capture images with even larger FOVs)(270-310° have been described in literature. By comparison, the improved low-parallax wide-angle camera lenses 320 of the present approach, used in an improved low-parallax multi-camera panoramic capture device (300), are purposefully designed with low distortion, particularly at or near the edges of the imaged FOV, so as to ease image cropping and tiling. Also, the present cameras, while wide angle, typically capture image light from a significantly smaller FOV than do fisheye lenses. For example, a camera for a regular dodecahedral device nominally captures images from a full width FOV of ≈63-75°. Whereas, an octahedral device can have cameras nominally capturing image light from a full width FOV of ≈71-110° width, a truncated icosahedral device can have cameras nominally capturing image light from a full width FOV of ≈40-45° width.

While the internal combination of the pre-stop wide angle lens group 365 and the post-stop eyepiece lens group 367, are not used as a stand-alone system for the present applications, if the compressor lens group 345a,b,c was removed, these two inner groups can also work together to form images at or near the image plane or sensor. In the optical designs of the camera lenses (320), these lens groups, and particularly the wide-angle lens group 365, visually resembles a door peeper lens design. However, while this combination of two groups of lens elements again may visually appear similar to a fisheye or door-peeper type lens, they again do not image with fisheye type f-theta lens distortion (e.g., H=fθ).

By comparison, the optical construction of the rear lens group (367), or sub-system, resembles that of an eyepiece, similar to those used as microscopic or telescopic eyepieces, but used in reverse, and without an eye being present. Eyepieces are optical systems where the entrance pupil is invariably located outside of the system. The entrance pupil of the eyepiece, where an eye would be located in a visual application, nominally overlaps with the plane where the aperture stop 355 is located. Likewise, the nominal input image plane in a visual application corresponds to the sensor plane (950) in the present application. The eyepiece lens group (367) was not designed to work with an eye, and thus does not satisfy the requirements for an actual eyepiece relative to eye relief, accommodation, FOV, and pupil size. But this eyepiece-like lens group solves a similar problem, and thus has a similar form to that of an eyepiece. Depending on the application, the optical design can more or less provide nominal optical performance similar to that of a more typical eyepiece.

This improved lens 320 of FIG. 8, is similar to the camera lens 120 of FIGS. 2A,B, but it has been designed for a more demanding set of conditions relative to parallax correction, a larger image size (4.3 mm wide), and a further removed entrance pupil to provide more room for use of a larger sensor board. This type of configuration, with multiple compressor lens elements, can be useful for color correction, as the glass types can be varied to advantageously use both crown and flint type glasses. In this example, the outer lens element 345a, or first compressor lens is a meniscus shaped lens element of SLAH52 glass, with an outer surface 338 with a radius of curvature of ˜55.8 mm, and an inner surface with a radius of curvature of ˜74.6 mm. Thus, an overall optimized improved multi-camera capture device 500 can have a nominal radius from the vertex of the outer lens element to a nominal NP point location of ˜65 mm. In this example, incident light 310 from object space 305 that becomes image light 315 is significantly refracted inwards (towards the optical axis 385) when it encounters the outer surface 338, but it is refracted inwards less dramatically than is provided by the first surface of the FIG. 2A lens.

The requirement to use a larger sensor board increases the distance between the image sensor plane and the entrance pupil or low parallax volume 392. In particular, the focal length is larger (5.64 mm) so as to project the image onto a large sensor. Within the LP smudge or low parallax volume 392, there are several potentially useful planes or locations of reference, including the paraxial entrance pupil, or a location of a center of perspective, or locations for non-paraxial chief ray NP points, or a location of a circle of least confusion where the LP smudge or parallax volume has a minimal size in the plane tangent to the optical axis. The entrance pupil is a good reference as it is readily calculated from a common first order optics equation. The axial location of a center of perspective is also a good reference as it is directly relatable to perceived image quality. While the distance from the image plane 360 to any of these locations can be used as a reference, an offset distance 375 to a paraxial entrance pupil can be preferred. In this example (FIG. 8), the entrance pupil is located ˜30 mm behind the image plane 360, for a negative entrance pupil distance to focal length ratio, EPID/EFL =−5.3:1. Depending on how it is measured, the LP smudge 392 can have an axial width of ≤2 mm.

The improved camera lens systems 320 of FIG. 8 provides an example for how the lens form can vary from that depicted in FIGS. 2A,B. In general, the lens form for enabling an improved low-parallax multi-camera panoramic capture device (300) has a common feature set, consisting of an initial compressor lens group which bends the light sharply towards the optical axis, a physically much smaller wide angle lens group which redirects the light into the aperture stop, and an eyepiece-like lens group which directs and focuses the transiting image light to an image plane. The requirement to reduce parallax or perspective errors, while enabling multiple polygonal shaped cameras to be adjacently abutted to form a larger improved low-parallax multi-camera panoramic capture device (300) brings about an extreme lens form, where lens elements in the compressor lens group can be rather large (e.g., 80-120 mm in diameter), while typically at least some lens elements in the wide-angle and eyepiece lens groups are simultaneously rather small (e.g., 5-10 mm in diameter). In these type of lens designs, the first compressor lens element or outermost lens element 345a, and adjacent outer lens elements of adjacent lens systems, can alternately be part of a contiguous faceted dome or shell. It is also typical that several (e.g., 2-4) of the lens element surfaces have aspheric or conic surface profiles, so as to bend or direct light rays transiting near the edges of the lens elements differently than those transiting near the center or optical axis. Typically, the wide-angle lens group 365 also has a lens element with a deeply concave surface. In some cases, during optimization, that surface can want to become hyper-hemispherical, although to improve element manufacturability, such profiles are preferably avoided. Another measure of the extreme characteristics of this lens form, is the offset distance of the paraxial entrance pupil (or similarly, the LP smudge) behind or beyond the image plane. Unlike typical lenses, the entrance pupil is not in front of the image plane but is instead pushed far behind or beyond it. This is highlighted by the negative entrance pupil to image plane distance/focal length ratio, EPID/EFL, which can range from −2:1 to −10:1, but which is typically ≥−4:1 in value.

Optimization of the size, position, and characteristics of the LP smudge or low parallax volume 392, as depicted in exemplary detail in FIG. 8, impacts the performance and design of the improved camera lens systems 320. The low parallax volume optimization is heavily impacted by the merit function parameters and weightings on chief rays for both spherical aberration of the entrance pupil and axial or longitudinal chromatic aberration of the entrance pupil. Lens element and lens barrel fabrication tolerances can also impact the size and positioning of this volume, or equivalently, the amount of residual parallax error, provided by the lens. Thus, even though these lenses can be considered to have an extreme form, optimization can help desensitize the designs to fabrication errors, and provide insights on how and where to provide corrective adjustments or compensators.

In designing objective or camera lens systems of this type for visible applications, it can be rather useful to use high index, low to mid dispersion optical materials, such as Ohara S-LAH53 or SLAL-18, including particularly for the compressor lens elements. As another option, the optical ceramic, Alon, from Surmet Corporation of Burlington, Mass., has comparable refractive indices to these materials, but even less dispersion, which can make it quite useful in designing these lenses. It can also be useful to use optical polymers or plastics in these lens designs, particularly to reduce cost and weight, but also for other reasons. The compressor lens elements, and particularly the first or outermost compressor lens element 345a can be a good candidate for a glass to polymer substitution, as it can be so large, and is subject to complex edge beveling. High refractive index optical polymers, such as OKP4 from Osaka Gas Chemicals, or EP5000 from Mitsubishi Gas Chemical, can be particularly useful for such purposes. Likewise, it can be beneficial to use an optical polymer for the deeply concave lens element (such as Zeonex E48R) just before the aperture stop 355, relative to fabricating surfaces with extreme hemispheric or conic profiles. Unfortunately, optical polymers have a much more limited range of optical properties than do optical glasses, and the high refractive index polymers have both lower refractive indices and more dispersion than do the glasses, which can constrain the optical designs or performance. It should also be understood that the camera lenses of the present approach can also be designed with optical elements that consist of, or include, refractive, gradient index, glass or optical polymer, reflective, aspheric or free-form, Kinoform, fresnel, diffractive or holographic, sub-wavelength or metasurface, optical properties. These lens systems can also be designed with achromatic or apochromatic color correction, or with thermal defocus desensitization. These alternate materials or optical components technologies can also be used for optical elements for the relay imaging systems that are subsequently discussed.

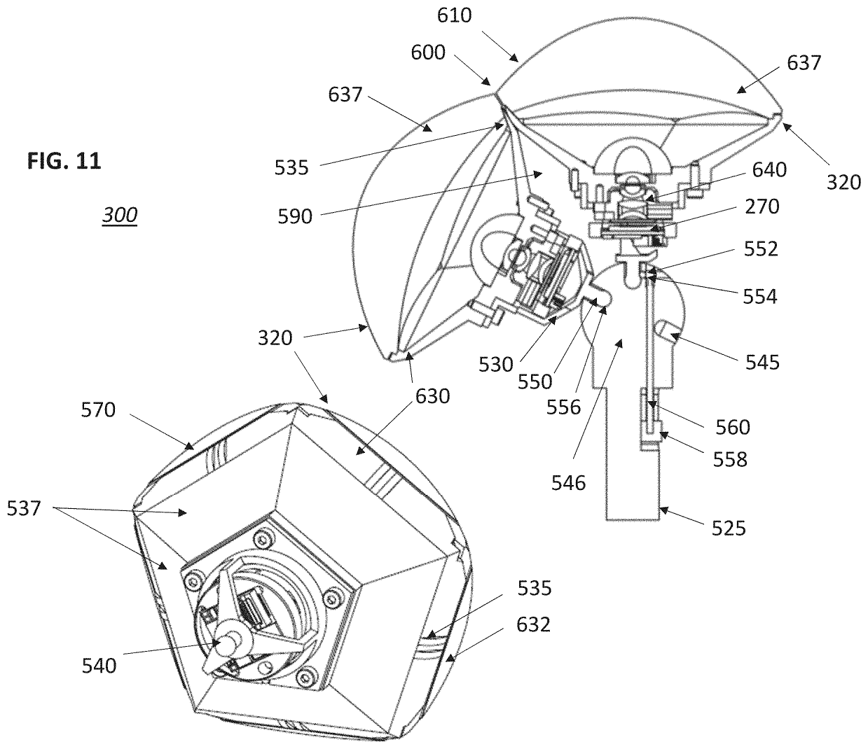

Enhanced situational awareness can be directly enabled by an improved low-parallax multi-camera panoramic capture device (300) with a low parallax camera lens 300, such as that of FIG. 8, with an appropriate lens design and use of optical detectors or sensors. For example, an optical event detection sensor, such the Oculi SPU, can be positioned at the image plane 360, and use its fast response and large dynamic range to detect abrupt changes of an object in a scene. The neuromorphic or event sensor technology is still relatively early in its development, and at present these sensors tend to have low spatial resolution compared to CCD or CMOS image sensors. Thus, as an alternative for providing situational awareness, a high resolution, large pixel count image sensor, such as the Teledyne Emerald 67M, with an addressable 67 mega-pixels, can be located at the image plane 360 of an appropriately designed lens 320. However, as this sensor is large, and a camera channel 320 needs to fit within a conical volume or frustum, the front compressor lens elements (345a,b,c) can become very large and be difficult to fabricate. These issues can be addressed by a reducing the sensor size (such as to a Teledyne Emerald 16M or 36M), or by reducing the FOV imaged by the camera lens, or a combination thereof. For example, if the overall polygonal form is changed from a dodecahedron to a regular truncated icosahedron, the imaged field of view captured by a camera lens (32) is decreased, a larger sensor can be supported, and the lens image quality improved, resulting in an improved angular resolution. FIG. 11 depicts a portion of an opto-mechanical system for an improved multi-camera capture device 300, as in FIG. 8, where cameras 300 have a sensor 270, such as an imaging sensor or an event sensor, provided at the associated internal image plane 360.

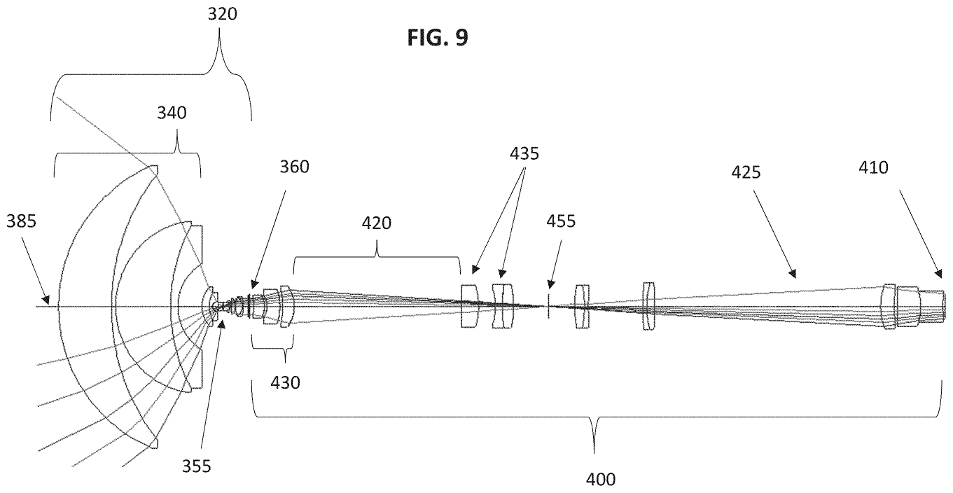

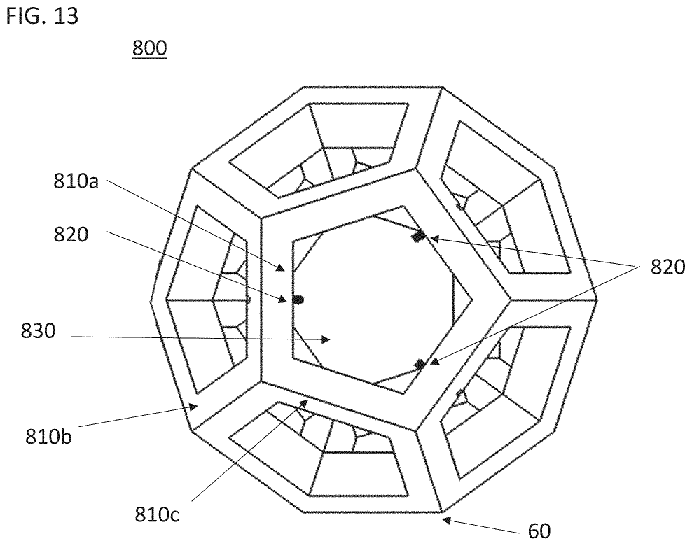

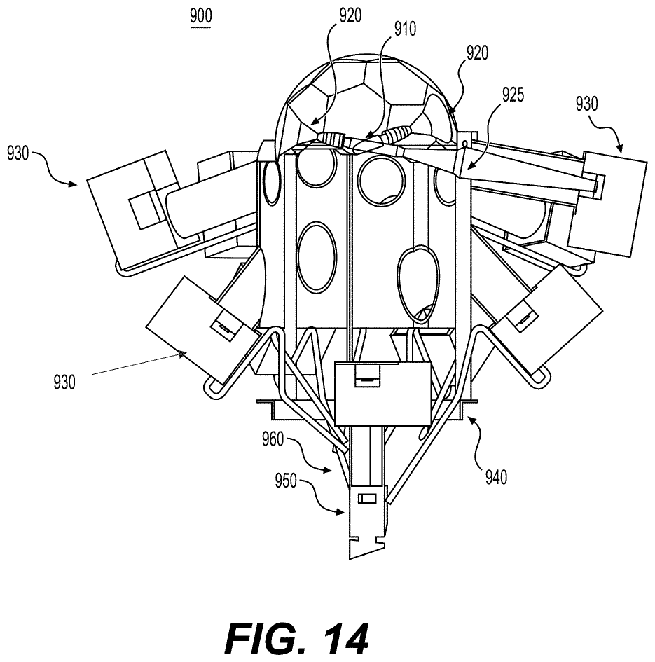

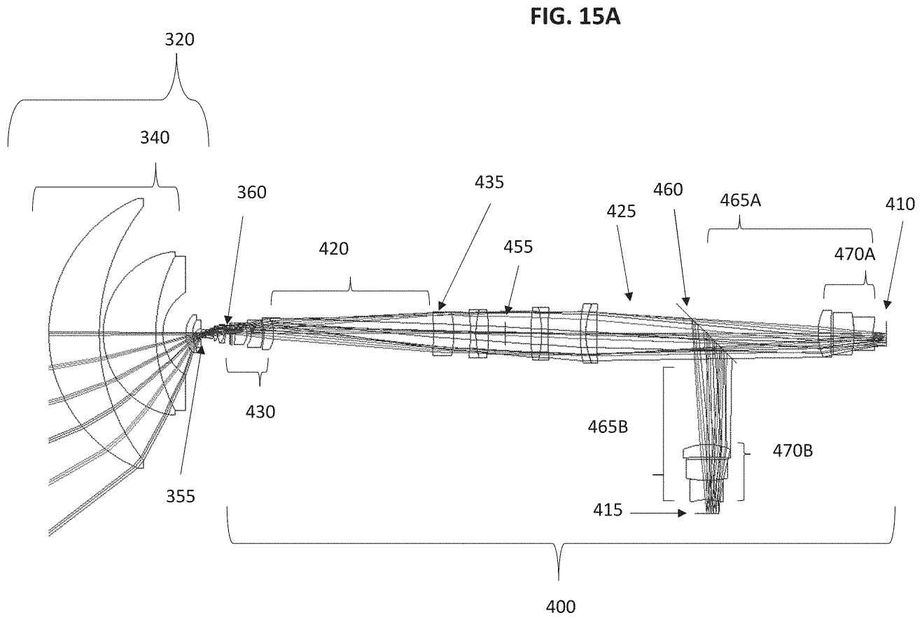

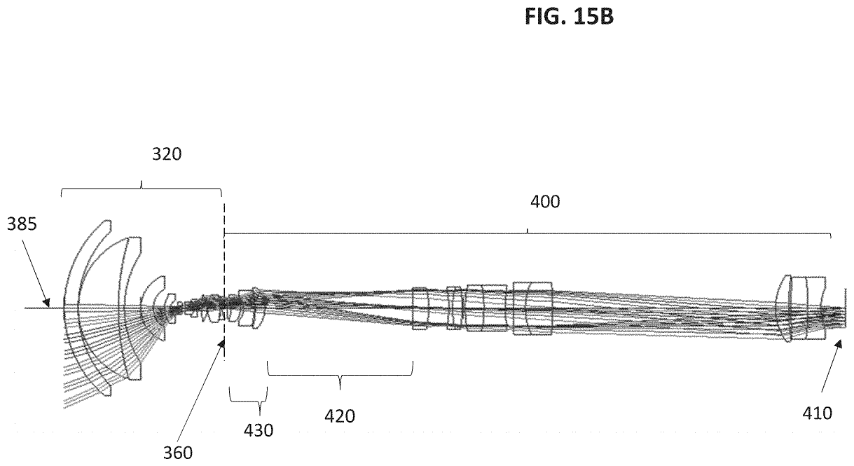

As another approach that can enable higher resolution imaging or dual modality sensing, and various situational awareness possibilities, an improved low-parallax multi-camera panoramic capture device (300) can include a low parallax camera lens 320, acting as an objective lens, paired with an imaging relay optical system. FIG. 9 depicts such a system, with objective or camera lens 320, including a compressor lens group 340, paired with an imaging relay 400, where the relay is a lens system having a nominal magnification of 1.5×.These lenses are nominally aligned along an optical axis 385. FIGS. 15A and 15B depict additional such examples of combination systems with an objective lens and imaging relay. In FIG. 9, the example camera lens 320 is similar to the one of FIG. 8, although the front compressor lens group 340 includes a cemented doublet. In this type of system, the original image plane 360 corresponds to a real aerial image that is an intermediate image to a second image plane 410 at the far end of the imaging relay. A large high resolution image sensor, such as the Teledyne 67M, can then be provided at this second image plane 410. The optical system would be appropriately designed so that the optical resolution and the sensor resolution approximately match. The aperture stop 355 of the objective lens (320) is nominally re-imaged to a secondary aperture stop 455 with the relay optics. The optical relay design 400 also includes a gap or clearance 420 between the outer surface of the last field lens element 430 and subsequent lens elements. FIG. 14 depicts portions of example opto-mechanical systems for an improved multi-camera capture device 300 having cameras 320 paired with an imaging relay and a sensor, in which an imaging sensor or an event sensor, is provided at an offset or secondary image plane 410. The system of FIG. 14 can include a nexus type internal frame (e.g., FIG. 13) that provides a hollow center or open space through which multiple imaging beams of image light from multiple camera channels can cross through each other. As will be subsequently discussed, the relay optics can also include beam splitting optics, mirrors, or other components to enable multiple sensing modalities or other functions per camera channel.

The optical system for an improved low-parallax multi-camera panoramic capture device (300) that enables enhanced imaging or situational awareness, and uses low parallax camera lenses 320 directly (e.g., FIG. 8) or with accompanying relay optics (e.g., FIG. 9 and FIGS. 15A,B), needs to be designed also accounting for the realities of including support opto-mechanics, sensors, electronics, and cooling or thermal controls. In this example, a dodecahedron type device has 11 cameras 320, and an electro-mechanical interface in the twelfth camera position. Image data can be collected from each of the 11 cameras, and directed through an interface input-output module, through a cable or bundle of cables, to a portable computer that can provide image processing, including live image cropping and stitching or tiling, as well as camera and device control. The output image data can be directed to an image display, a VR headset, or to further computers, located locally or remotely. Electrical power and cooling can also be provided as needed.

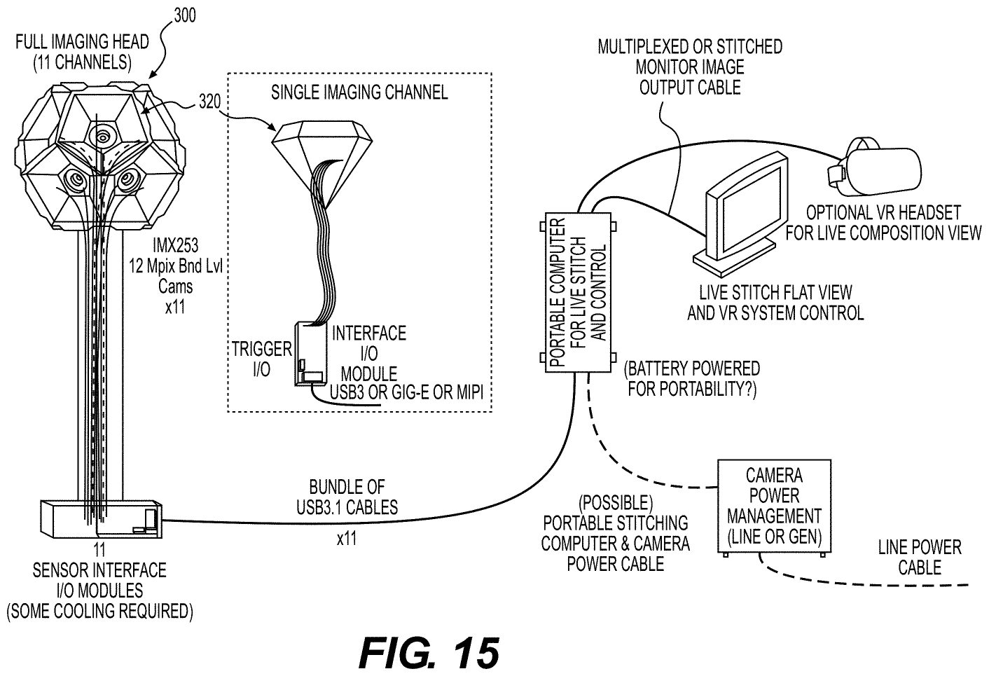

To help reduce thermal gradients between the sensors and their electronics, and the optics, micro-heat pipes or Peltier devices can be used to cool the sensors and re-direct the heat. The heat may be removed from the overall device by either active or passive cooling provided through the electro-mechanical interface in the twelfth camera position, shown in FIG. 10. This cooling can be provided by convection or conduction (including liquid cooling) or a combination thereof. Outside ambient or environmental factors can also affect performance of a multi-camera capture device. These factors can include the effects of the illuminating ambient light, or thermal extremes or changes in the environment. For example, as sun light is typically highly directional, a scenario with outdoor image capture can result in the cameras on one side of the device being brightly illuminated, while the other cameras are seeing plenoptic illumination from the scene or even are in shadows. In such instances, the captured images can show dramatic exposure variations, which can then be modified by exposure correction, which may be provided locally by various means. For example, exposure correction can be enabled by imbedding optical detectors in the seams 160 or vertices, between outer lens elements 137 (e.g., see FIG. 1). These abrupt exposure differences can also cause spatial and temporal differences in the thermal loading of some image sensors, as compared to others, within a multi-camera capture device 300. Thus, sensor cooling, whether enabled by heat pipes, heat sinks, liquid cooling, or other means, can be designed to account for such differences. The performance can be validated by finite element analysis (FEA).

As part of countering such issues, an improved multi-camera capture device 300, as shown in FIG. 11, can include features to provide kinematic type mounting of individual cameras 320 or objective lenses. In particular, FIG. 11 depicts two views of a dodecahedron multi-camera capture device 300, including a partial cross-section in which 11 pentagonal cameras 320 are mounted to a central support 525 that occupies the nominal position of a twelfth potential camera channel. Each camera 320 has a separate base lens assembly or housing 630 that consists of a lens mount which mounts the compressor lens (637) while also mounting the inner lens elements 640 that together comprise a base lens assembly. The compressor lenses 637 can acts as field stops for their respective camera channels, or a baffle (not shown) can be provided within the lens housing 630, proximate to the associated compressor lens, and act as the field stop. Although for each camera 320, the lens elements and housings 630 fit within the nominal conical space or volume, they need not nominally fill that space. Indeed, the abrupt ray bending provided by the compressor lens elements can mean that the inner lens elements 640 and their housings or barrels underfill the available space, and the overall lens housings 630 can taper further inwards, potentially leaving an open inner volume 590 between adjacent lens assemblies. Adjacent lens housings 630 are separated by seams 600 that can be completely or partially filled with an adhesive.

The housings 630 or base lens assemblies of FIG. 10 also include a turned section, that can be machined on a CNC multi axis (5-axis) machine, and that mates with a tripod-like channel centering hub 530. The lens housings 630 may be fabricated from a material such as stainless steel or invar. The channel centering hubs 530 can be entirely turned on a lathe except for the pentagonal flange, which is completed in a finish operation after the lathe. Being turned on a lathe means that exceptional concentricity and runout can be achieved, helping with the ultimate alignment of the channel. The housing 630 mates with the inside diameter of the channel centering hub 530 which is a key part of a central mount mechanical assembly that is designed to have a fit with it that ranges from a slip fit to a light interference fit, so as to ensure axial alignment without significant variations due to gap tolerances. This same fit reduces perpendicularity errors with respect to the channel axis.

The tripods or channel centering hubs 530 also include a turned section or ball pivot 540 that mates with a socket 545 of a spherical socket array 546 provided on the central support 525. In this system, the camera 320 located in the polar position, opposite the central support 525, is a rigidly placed reference channel. The center support 525 consists of a cylindrically shaped post with a ball on the top. The geometries for the center support 525 and tripods or centering hubs 530 can be designed to provide more space for a sensor 270, power and communications cables, cooling lines, and mechanisms to secure the lens housings 630 or cables. In this example, the ball contains sockets 545, each of which can receive a ball pivot 540. The ball pivots 540 are at the ends of extended pins or ball pivot arms 542. Although this ball and socket portion of the center support 525 mount can be expensive to machine, given the precision expected with respect to the position and depth of the sockets, the advantages are that centerline pointing is controlled, while there is only a single part per device 300 that demands exceptional precision. Whereas, each of the camera channels 320 may be machined with less precision, which eases both the fabrication and replacement costs.

The individual camera lens housings 630 of FIG. 11 can also be provided with external or outside channel to channel datums 535, located midway along the pentagonal sides or faces 537. Each of these channel-to-channel datums 535 can comprise two parallel convexly curved slightly protruding bars that are separated by an intervening groove. These datums are designed to provide both single point or localized kinematic contacts or interactions between lens housings, such that the datum features interweave in such a way that only one part or housing will dominate in terms of tolerance. Since they are interwoven, only the variation of one part will influence the distance between each camera channel, and thus influence the angle between the channels. In particular, if one datum 535 is larger it will dominate because the other will not make contact. Thus, only one tolerance contributes for two parts. That the channel-to-channel datums 535 are interwoven from one camera 320 to another, also limits lateral movement between mating (pentagonal) faces or sides, while allowing limited angular movement of the lens housings 630.

In this system, it can be useful to designate a camera channel as the primary channel, and mount it accurately, but in a fixed way, that it can serve as a datum to which the other camera channels are directly or indirectly aligned. As an example, to take advantage of symmetry, the designated primary channel 610 can be the one opposite the support post 525. Individually, and in aggregate, the interactions between camera lens housings 630 or base lens assembly's limits mechanical displacements and wedge or channel pointing errors (roll, pitch and yaw) between cameras due to both the ball and socket arrangement and the datum features (535). Each camera channel assembly works together with its neighbors to limit channel pointing error. The portion of the base lens assembly (630) that holds the outer lens element 637 or compressor lens also has internal functional datums that can locate the compressor lens perpendicular relative, to the optical or mechanical channel axis, and it has additional internal datum features that limit axial misalignment.

The use of the alignment features depicted in FIG. 11, and particularly the ball pivot and socket datums (550 and 556) and the channel-to-channel datum features 535 reduces the risks of rotation, pivoting, or splay from one camera channel (320) to another. Thus, these features also help enable the seams 600 between cameras 320 to have more consistent thicknesses, with respect to the design values, than may have happened otherwise. The use of the internal features within the lens housing (e.g., compensators, adjustments screws, and shims) and external features between lens housings (e.g., channel to channel datums, ball and socket datums, and a channel loading support) help control Core FOV or Extended FOV pointing, so that one camera channel can be aligned to another adjacent channel. The device (300) can also have a channel loading support (not shown) that can help biases secondary or tertiary camera channels against the primary channel. The combined use of channel-to-channel datums, ball and socket datums (FIG. 11), a channel loading support, and adhesive in the seams 600, can also help desensitize the device to mechanical or thermal loads, while controlling or limiting the occurrence of mechanical over-constraint or under-constraint between adjacent camera channels (320).

Lens elements, including the outer lens element 637 can be mounted to the housing 630 with a compliant adhesive. Along the edges seams 600, spanning the outermost edge portion of the adjacent outer lens elements 637, these lens elements can be nearly abutting, and separated by a gap that can be only 0.5 mm wide, or smaller. In practice, the optimization of the seam width can depend on how brittle or compliant the lens material is (glass or polymer), the flexibility of a seam filling adhesive, the use of other protective measures, and the application.

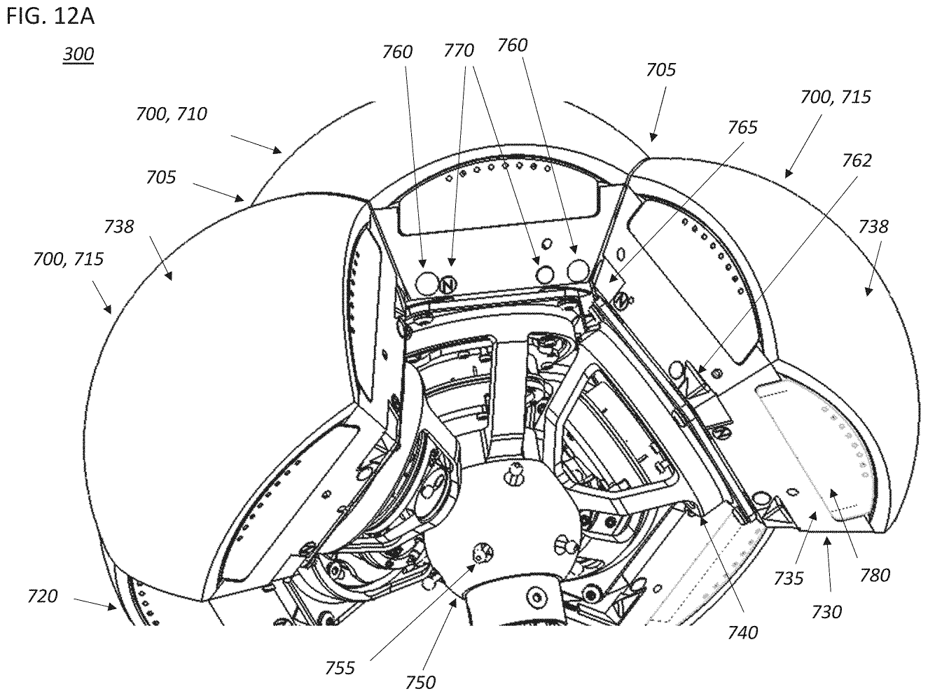

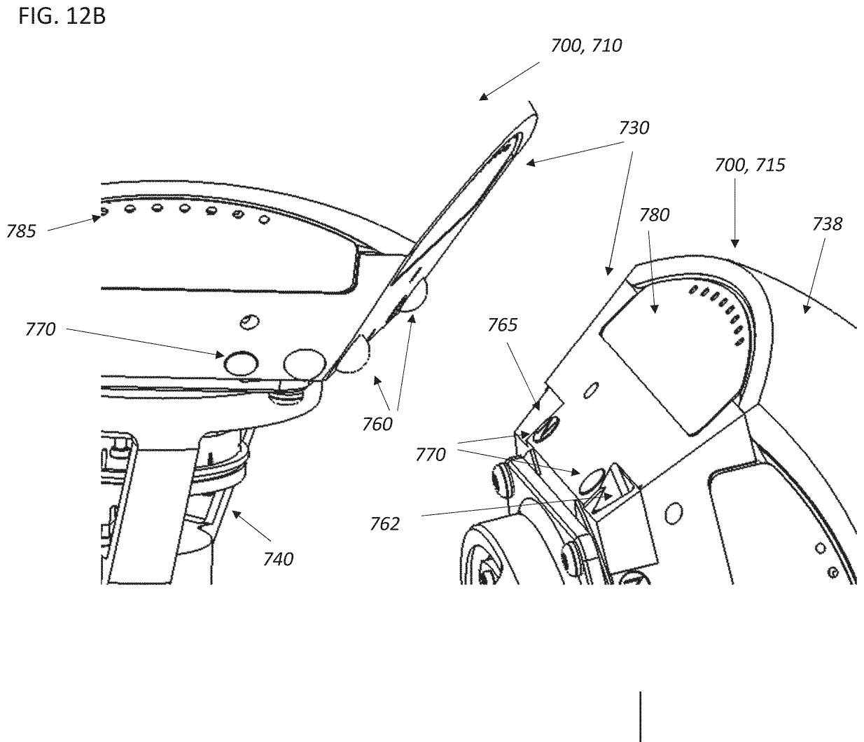

FIG. 12A depicts an alternate version for an opto-mechanical design to that of FIG. 11 for camera lens housings that generally fit within pentagonally-conical or hexagonally0conical limiting volumes so as to position and support adjacent and abutting low-parallax camera channels. In particular, FIG. 12A depicts portions of five adjacent imaging lenses or camera channels 700, including an upper primary channel 710, and four secondary channels 715, that are separated by narrow seams 705. The camera channels 700 each include a lens housing 730, a polygonal shaped outer lens element 738, and a channel centering hub or tripod 740 that mounts and interfaces to a central hub 750. Part of at least one tertiary camera channels 720 is also depicted. FIG. 12B then depicts an exploded perspective view of a portion of the design of FIG. 12A, providing greater detail of the interface of one of the secondary channels 715 to the primary channel 710.

In the design of FIGS. 12A and 12B, unlike in the examples above using the channel to channel datums 335, channel to channel datums include kinematic ball, flat, and vee features. In particular, the primary channel 710 can include a plurality of balls 760 (or otherwise partially-spherical or arcuate surface) protruding from faces or sides 735 of the lens housing 730. During assembly of a primary camera channel 710, a pair of the balls 760 can be aligned using fixturing (not shown) so as to protrude from their respective side or face 735 of housing 730 by a prescribed amount, within a tolerance. The lens housings 730 of the secondary channels 715 can then be fabricated with a corresponding vee slot 762 and flat 765. During assembly of the multi-camera capture device 300, the primary channel 710 can be aligned to the central hub 750 with a pin (not shown) and mounted using a tensioned cable or a bolt to pull the channel centering hub or tripod 740 into contact with the central hub 750. A secondary channel 715 can then likewise be mounted to the central hub 750 using a second spring tensioned cable 755. As the assembly process occurs, spanning or across the seam 705, first of the alignment balls 760 protrudes to contact the corresponding secondary vee slot 762 and a second of the alignment balls 760 protrudes to contact a corresponding one of the flats 765. The interaction of the first of the kinematic balls 760 with the kinematic vee slot 762 stops movement in two directions, positioning the two camera channels relative to each other with both accuracy and precision. Likewise, the second of the precision balls 760 on the primary channel can interact with the corresponding flat 762 of the opposing secondary channel 715 to stop rotation in a third direction and provide a stable and repeatable relative positioning of the two camera channels to each other. As an example, the balls 760 can be precision stainless steel balls with a nominal 0.188-inch diameter, and the precision vee slots 762 can be have a nominal 110-degree angle.

The opto-mechanical interface of the multi-camera capture device 300 depicted in FIGS. 12A and 12B also includes magnets 770 on the camera lens housings 730. For example, on a side face 735 of the primary channel 710, one of the magnets 770 can be provided near each of the balls 760. For example, on a primary channel side face, the two magnets 770 can be mounted with their north poles facing outwards. Each magnet can be set and glued within a machined pocket to a precise height while being oriented so that the magnet will not interfere with the magnet in the next assembly, and the poles will be attracted. Lens housings 730 are preferably fabricated from stainless steel, such as alloy 416, which has magnetic properties, that help collapse the inwards directed magnetic field and enhance the outwards directed (e.g., towards a secondary channel) magnetic field.

On an adjacent secondary channel 715, two magnets 770 can be provided adjacent to the vee slot 762 and the flat 765, with their South poles facing outwards. When the two camera channels are brought into proximity, the effect of magnetic attraction between North and South poles will span the seam 705. This magnetic attraction can ensure that the two camera channels are pulled towards each other, such that the vee slot 762 and the flat 765 are in contact with their respective precision balls 760, thus bringing two channels into kinematic alignment and preventing under constraint relative to channel-to-channel separation or rotation. As an example, permanent rare earth magnets, part number D32SH from K&J Magnetics of Pipersville, Pa., that are 3/16″ dia.×⅛″ thick, with a pull force or 1-2 lbs., can be used. With approximate gap across the seam between the magnets 770 of 0.75 mm, and with the magnets mounted into a lens housing 730 fabricated from stainless steel, the attracting strength between two magnets can be ˜0.5 lbs.

The use of magnets 770 mounted to the side faces 735 of the camera channel lens housings 730 can be configured in various ways. For example, the pair of magnets on the side face 735 of a primary channel can be oriented for their direction of magnetism as a North-North pair, or a South-South pair, or a North-South pair. In FIGS. 12A and 12B, some magnets 770 are marked with an “N” to indicate that their north pole is oriented outwards. The magnetic orientations can vary amongst the side faces 735 of the primary channel 710. In alternate configurations, a primary channel face 735 can have only one magnet or no magnets, while other primary channel faces 735 are provided with a different number. Magnets can also be positioned in other locations on a side face, and not just adjacent to precision balls 760, vee slots 762, or flats 765. The nominal magnetic strength or pull force need not be identical for magnets on a side face, or from one side face to another, of a camera channel (whether primary or otherwise).

As depicted in FIGS. 12A and 12B, magnets 770 are provided between the primary channel 710 and the secondary channels 715, and on all side faces 735 of the secondary channels 715. Use of magnets between the secondary channels 715 and tertiary channels 720 is likewise anticipated. However, use of magnets 770 between secondary channels 715 or between tertiary channels 720 can be optional depending on the design. Likewise, the nominal strength of magnets 770 used between secondary channels 715 and tertiary channels 720, or between secondary channels 715, or between tertiary channels 720, need not be identical to those used between the primary channel 710 and the secondary channels 715. In particular, these secondary magnets, in locations other than on or about the primary channel 710, can be selected to have lower magnetic strengths.

In the nominal system depicted in FIGS. 12A and 12B, the primary channel 710 can be aligned into the central hub 750 with a pin, and attached to the hub with a bolt. The central hub 750 can be fabricated from stainless steel (e.g., alloy 440). The secondary channels 715 can be mounted by being pulled to the hub 750 by the cables 755, while also being pulled to the primary channel with magnets 770, such that the vee grooves 762 and the flats 765 are kinematically in contact with the precision balls 760 on a side face 735 of the primary channel 710. The tertiary channels 720 can also have two balls, but in some examples the balls 720 can be in different locations. For instance, balls on the tertiary channels can be located one on each side and the other in a corner. The tertiary channels 720 can be pulled to the hub by cables, and pulled to the secondary channel by magnets, while being kinematically aligned by a precision ball to a “V” created by the intersection of two adjacent secondary channels. Tertiary channel rotation is prevented by contact of the other ball against a flat on a secondary channel.

In other examples, a mounting plate, channel loading support, or channel nesting plate (not shown) can also be provided with magnets 770, springs, flexures, vlier pins, or other devices, to provide underlying support to the tertiary channels. Although the magnets 770 are shown in FIG. 12A being used in a multi-camera capture device 300 having balls 760, vees 762, and flats 765, magnets can also be used in the prior devices of FIG. 11 where the lens housings have the low-profile channel to channel datums 335. Magnets can also be used on the lens housings for devices (300) with yet other opto-mechanical configurations, including the example of FIG. 13 with the nexus internal frame 800. Moreover, although the example of FIGS. 12A and 12B show the use of both the magnets 770 and the ball-based alignment features, in other instances, the magnets can be omitted. Moreover, the magnets 770 can be used in the absence of the ball-based mounting features. Also, the choice or design of channel-to-channel interfaces or datums can be provided in other combinations. Without limitation, a first interface between the primary channel and a first of the secondary channels can use the ball-based and magnet alignment mechanisms, whereas a second interface between the primary channel and a second of the secondary channels can use only the ball-based features or only the magnets. Likewise, as a design alternative, the ball datum features can be provided on the secondary camera channels, while the vee and flat datum features are provided on the primary and tertiary camera channels. As another alternative, the ball and vee or flat datum features can be mixed in arrangement across or amongst camera channels, whether primary, secondary, or tertiary. For example, a sidewall of the primary channel can have a ball datum feature and a vee-datum feature, while the sidewall of the adjacent and abutting secondary camera channel has a corresponding flat and ball datum features. Moreover, other alignment and/or registration techniques described herein can be used in place of, or in conjunction with, the features illustrated in FIGS. 12A and 12B.

Improved low parallax camera lenses 320, such as the ones in FIGS. 2A, 2B, and 8, can be designed to include beam splitters and second optical sensors therein. However, as illustrated by both the lens forms depicted in FIGS. 2A and 2B and FIG. 8 and the exemplary opto-mechanical designs depicted in FIG. 11 and FIGS. 12A and 12B, because of the confining conical volume or frustum, and the needs for other hardware, there is limited space to add these components. As one approach, if the improved low-parallax multi-camera panoramic capture device (300) provides more camera channels as compared to devices having a regular dodecahedral form, and instead for example has a form of a regular truncated icosahedron or of a truncated rhombic triacontahedron (also known as a chamfered dodecahedron), than the FOV captured by any given camera channel (320) in this alternate device can be smaller. Easing the FOV per camera channel can in turn help to ease the extreme shape and space constraints of both the lens form (e.g., FIGS. 2A,B and FIG. 8) and the opto-mechanics (e.g., FIG. 11 and FIGS. 12A and 12B), and thus enable use of a larger optical sensor at the image plane or the easier inclusion of a beam splitter and a second optical sensor. Going to a chamfered dodecahedron does introduce a mix of regular and irregular hexagons, as compared to the icosahedron that has only regularly shaped hexagons. Essentially, the polyhedral form of the overall improved multi-camera panoramic image capture device 300, relative to the type of polyhedron selected (e.g., type of Goldberg polyhedral) is being selected to help both the optical design or lens form, and the opto-mechanical design. In optical terms, the optical invariant or Lagrange of the individual camera channels is being selected to optimize the optical design, the sensor selection, and the imaging performance of the objective lens (320), as in FIG. 8, or of a combination of objective lens and relay optics (e.g., FIG. 9 and FIGS. 15A and 15B). However, increasing the number of camera channels in a device also increases the number of seams and vertices, which in turn may increase the overall mechanical complexity. This may complicate use of an opto-mechanical design approach for a device with a “solid” central hub (e.g., FIG. 11 and FIGS. 12A and 12B). In the case of systems without relay optics (e.g., FIG. 8 and FIGS. 12A and 12B) in which at least some camera channels are also providing secondary sensors, space can be available to allow outer ring camera channels to have opto-mechanics that protrude outside of their limiting polygonal conical volumes and away from the device center.

As an alternative which can ease mechanical constraints, FIG. 13 provides an example of an alternate mechanical configuration having a nexus internal frame 800, with numerous pentagonal faces 810 arranged in a regular dodecahedral pattern with a hollow center. Generally, an internal frame 800 is a polygonal shaped frame that has an array of adjacent polygonal mechanical faces with mounting and alignment features. Internal frame 800 can be designed as a mount mechanical assembly for an 11-camera system, with a support post attaching in the 12th position (similar to FIG. 11 and FIG. 12A,B). A polygonal internal frame, or half or partial internal frame can also be used in a partial or hemispheric system, where the camera assemblies, including imaging sensors are mounted directly or indirectly to the frame. Connections, cables, and wiring for data transfer and cooling can then be directed out through the open polygonal portion 830 of a face 810 and into the hollow center of the internal frame 800 and out through an open polygonal portion 830 of another face 810. Alternately, a hemispherical system (e.g., see FIG. 14) with an internal mounting frame 800 can provide a central hollow or open space (e.g., a nexus) to enable image light beams to cross through an opposing pair of open polygonal portion 830 of faces 810 so as to transit subsequent relay optical systems (400) and reach remote optical sensors at a secondary image plane 410. Positionally, the width of the gap or clearance 420 in the relay optics (see FIG. 9) between the outer surface of the last field lens element 430 and the nearest subsequent lens elements 435 nominally matches the width of the central hollow volume between opposing faces 810 provided by the nexus internal frame 800. For example, clearance 420 can be 75 mm wide. But it is noted that the field lens elements 430 and their housing can protrude modestly through the open polygonal portion 830 of face 810, and into the central volume of the hollow center, as long as they do not block imaging light of an adjacent objective lens 320. In such a case, the clearance between lens elements would be less than the width of the hollow center of the internal frame 800. For example, width of clearance 420 can be 10 mm smaller than the central width.

As shown in FIG. 13, a nexus internal frame 800 can have a pentagonal face (810A) that can have three adjustors 820, such as set screws or flexures, oriented nominally 120° apart, that can interact with mounting and alignment features on the camera housing and thus be used to help align a given camera channel. For an improved multi-camera panoramic image capture device 300 constructed in a dodecahedral pattern, the internal frame would also be dodecahedral with pentagonal faces and it would be oriented with the internal pentagonal faces nominally aligned with the external pentagonal geometry. The internal frame approach can be used with other polygonal device structures, such as that for an octahedron, an icosahedron, or a chamfered dodecahedron. In such cases, at least some of the pentagonal faces 810 would have other polygonal shapes, such as hexagonal.

An internal frame 800 can be machined separately and assembled from 2 or more pieces, or it can be made as a single piece structure by casting or 3D printing. Although, the fabrication of a single piece frame could be more complex, the resulting structure can be more rigid and robust, and support tighter mechanical tolerances. For example, a dodecahedral frame (800) with a hollow center could be cast in stainless steel, and then selectively post-casting machined on the faces 810 to provide precision datum features, including flats, vee-slots, or ball mounting features (e.g. similar to FIGS. 12A,B). In particular, one or more pentagonal faces 810A, 810B, or 810C can be provided with one or more adjustors 820 that can be used to nudge the respective camera channel against a precision v-groove structure (not shown). These v-groove structures can be fabricated into, or protruding from, an inside edge of a pentagonal vertex 60 of a pentagonal face. Alignment balls can be mounted to the faces 810 or to the interfacing adjacent lens housings, or to a combination thereof. This internal frame 800 can then be provided with flexures or adjustors on all or most of the pentagonal faces, to provide kinematic type adjustments and to reduce or avoid over constraint during device assembly and use.

As previously, the mounting and adjustments for secondary channels can have a different design or configuration than those for a primary channel. In these improved devices (300), springs, flexures, magnets, or adhesives can be used on or within an internal frame 800 to provide a low stress mechanical linkage or connection between the lens housings of adjacent camera channels, and also between the camera channels and the nexus internal frame 800, or between different portions of the internal frame, so at help limit under-constraint or over constraint between the assemblies or lens housings. As another option, an internal frame can be at least in part made with a more compliant material, such as brass or Invar.

As discussed previously, an issue that can occur with an improved multi-camera capture device 300 is that with the plurality of camera channels and respective image sensors confined within a nominally spherical shape, there is little room to include other components or capabilities. Thus, for some applications, devices with a generally hemispherical configuration, with potential room underneath for other hardware, can be valuable. However, because the outer lens elements and cameras are typically polygonal in shape, a hemispherical device can have a jagged or irregular circumference. Also, in such systems, one or more of the cameras can be designed with folds (e.g., using mirrors or prisms) so that the optical paths extend through the bottom irregular circumferential surface. This construction can provide more room for use of modular sensor units that can be swapped in and out.

However, as an example, with a “hemispheric” version of a truncated icosahedron, with 6 camera channels with pentagonal faces, and 10 with hexagonal faces, it can be difficult to provide space for the opto-mechanics to fold so many optical paths. FIG. 14 depicts an alternative version of an improved multi-camera capture device 300 in which image light collected by the respective camera objective lens systems 920 is directed along a nominally straight optical path, through the nominal image plane, and then through an image relay optical system (925) to a more distant image sensor located in a sensor housing 930. The original image plane provided by an objective or camera lens system is essentially a real intermediate image plane within the larger optical system. It can be re-imaged with a magnification (e.g., 1:1 or 2.75:1) to a subsequent image plane (not shown) where an image sensor is located. Thus, advantageously, the image sensors can be larger, and provide a higher pixel count, and the relay lens systems 925 can re-image the image provided by the objective lenses (920) at an appropriate magnification to nominally fill the more distant sensor with a projected image. Image light from the respective cameras 920 crosses through a central volume or nexus 910 on its way through the respective relay lens systems 925 (e.g., gap 420 in FIG. 9). The relay lens systems 925 can include field lenses (e.g., field lenses 430 in FIG. 9) after the image plane of the camera lenses, which can be mounted within the near side of a nexus internal frame. Light can then cross the hollow central volume of the nexus internal frame and interact with subsequent lens elements. The improved multi-camera capture device 300 also includes a support structure 940, a support post 950, and cabling 960 for supplying power and extracting signal (image) data. The support structure 940 can provide more substantial support of the sensor housings 930 than is illustrated in FIG. 14, including by the addition of a space frame or lattice work of support members interconnecting the relay systems 925, sensor housings 930, and other associated hardware. The system can also include mechanical design features to improve robustness or to decrease vibration sensitivity.

The basic pairing of an objective lens that is a low parallax camera lens 320, with a refractive or lens-based imaging relay optical system 400 was shown in FIG. 9. Simplistically, the imaging relay 400 images or magnifies the image plane 360 to a secondary image plane 410 with adequate image quality thereto. However, the more extreme the lens form is, for the objective lens (320), the more difficult this becomes. As suggested previously, shifting from a regular dodecahedral form for the design of an improved low-parallax panoramic multi-camera capture devices 300, to another polyhedral form, such as that of a regular truncated icosahedron or of a truncated rhombic triacontahedron, can reduce the Lagrange or optical invariant supported by the camera channels. In this case, the design of both the objective lens and the relay optics can be eased, to improve performance or manufacturability.

As one aspect, in a system intended to optimize imaging performance to a secondary image plane 410, it can be advantageous to design the objective lens 320 to have a F-number of about F/2.5-F/3, and a relay with a magnification in the 1.5×-2.5× range, so that the speed or F-number of the image light 425 to the secondary image plane 410 is preferably in the F/4-F/7 range, so as to generally balance the effects of aberrations and diffraction. For systems or channels with higher resolution sensing, or smaller pixel sizes, at the secondary image plane 410, faster performance (e.g., F/4) will likely be needed. In some systems the preferred relay magnification can be more or less than 1.5×-2.5×, and for example, may be as little as 1× or as much as 5-10×.

Additionally, when the example improved low-parallax objective or camera lens 320 of FIG. 8 was designed, the target height and width of the image plane 360, or the size of the conical volume or frustum of the entire camera channel, were in part determined by the size of the imaging sensor, rather than the size of the optically active or pixelated area. In particular, additional space is needed to clear the entire sensor package, including the frame and electrical and cooling interconnects or hardware. As the difference between the active area and entire sensor package size can be significant, the added burden on the lens design to provide that larger clearance can be substantial. But in a system with an objective lens and imaging relay, as in FIG. 9, a larger volume needed for the sensor, sensor package, and other support hardware is shifted to a more accessible location remote from the image plane 360. Thus, the targets for the size of the image plane 360 can be more driven by optical considerations, such as Lagrange, objective lens performance, or imaging performance to the intermediate image plane (360) or to a subsequent image plane 410. In particular, optimizing the size of the image plane 360 to optical considerations, instead of mechanical ones, can allow the Low-parallax volume 188 or NP point 190 to be shifted closer to the image plane 360, which in turn can ease the lens design and assist in providing the target parallax performance.

Advantageously, the objective lens 320 and the imaging relay 400 can be coherently optimized or designed, sacrificing imaging performance or increasing aberrations for the objective lens, to share the burdens with the imaging relay, so that overall imaging performance to a secondary image plane 410, is improved. By comparison, typically the imaging performance presented by a first imaging lens is not compensated by the second imaging lens (e.g., the relay), and a result, as measured by MTF, is a product of the MTF of the individual lens systems. But the current approach for developing optically coherent designs in which a low-parallax objective lens is paired with an imaging relay, with compensating aberrations, is best pursued selectively. For example, with reference again to FIG. 8, the front portion of the camera lens 320, comprising the compressor lens group 340 and wide-angle lens group 365, are particularly designed to provide both the desired parallax performance by limiting the extent of the low parallax volume 188, or the positioning of offset NP points 192 therein (see FIG. 5C). For example, as previously, depending on the lens design, device design, and application, residual parallax errors for a lens system, as measured by a perspective error, can be reduced to ≤0.5 pixel for an entire Core FOV, the peripheral fields, or both. Likewise, the extent of the LP smudge 188 can, as an example, again be limited to ≤2 mm, by optimizing by limiting spherical aberration of the entrance pupil or controlling the propagation of the outer chief ray fans. In designing an optically coherent system having a low parallax objective lens 320 combined with an imaging relay 400, the objective lens, and particularly the first two lens groups (compressor lens group 340 and wide-angle lens group 365) can be designed to provide a target parallax performance, and then during the subsequent design of the entire system, inadvertent degradation of the parallax performance needs to be avoided. While the designs of the third or eyepiece-like lens group 367 and the imaging relay 400 do not affect entrance pupil aberrations, and thus do not impact actual chief ray propagation through the first two lens groups, they must change downstream chief ray trajectories to arrive at the respective first and second image planes. The third lens element group attempts to balance all aberrations created in the first two groups to form an image at the first image plane. The relay magnifies the first image and can further attempt to balance all aberrations at a secondary image plane. In a coherent optical design, aberrations at the first image plane can be sacrificed to benefit aberrations at a secondary image plane.

Furthermore, while pursuing an optically coherent lens design of an objective lens 320 with an imaging relay 400 (e.g., FIG. 9 and FIGS. 15A and 15B), the design of an eyepiece-like rear lens group 367 can be changed or relaxed to selectively sacrifice imaging performance to a local image plane 360, so as to ease the relay optical design or improve imaging performance to a secondary image plane 410, or both. For an example of such trads-offs, relative illumination (RI), telecentricity, lateral color, distortion, image size, and aberration control or MTF requirements can be relaxed to varying and different extents to the intermediate image (e.g., image plane 360), while these same attributes can be simultaneously optimized at a secondary image plane 410. Simultaneously, similar trade-offs can be applied to other optical aberrations (e.g., spherical, coma, astigmatism, field curvature, and longitudinal color or axial color) to help provide a sufficiently resolvable image or MTF to the secondary image plane 410. As an example, preferably, the optical image resolution or MTF at the secondary image plane nominally equates to the sensor pixel size, or a multiple thereof if a Bayer color filter or equivalent is used.

Many aberrations, such as spherical aberration, are frequently defined by their 3^{rd} order mathematical equations, but more complex behaviors often occur in actual lenses, that are sometimes well described by accounting for higher order terms (e.g., 5^{th} and 7^{th} order) in the model or design optimization. front color, as depicted in FIG. 5E is a simple B-R color position difference. But as shown in FIG. 5F, color parallax exhibits more complex differences across the imaged field, which can be attributed to chromatic spherical aberrations. Thus, during coherent lens optimization, it can be more broadly useful to both optimize or control chromatic spherical aberration (spherochromatism) of the objective lens at the entrance pupil and to sacrifice lateral color at the first image plane so as to limit front color (FIG. 5E), or color parallax differences (FIG. 5F), or color differences in the widths or positions of the low parallax volume 188 (FIG. 5C). As discussed previously, the sacrificed lateral color performance can then be compensated for by the relay lens when designing to the final image plane. When properly controlled, chromatic spherical aberration (spherochromatism) at the entrance pupil of the objective lens can be a few millimeters or less (e.g., ≤2 mm).

However, when designing an optically coherent objective lens and imaging relay combination, particular care can be needed to limit front color (FIG. 5E), as it can cause residual visible color shading and color perspective artifacts (e.g., see FIG. 5F) in overlapping FOVs near the seams during image tiling. During lens design, reducing front color (e.g., to ≤0.2 mm) can help drive the RGB curves closer together at or near the edges and vertices of the outer compressor lens element. Thus, subtle differences in color parallax correction will be reduced. Reducing front color will also reduce the size of the blue clear aperture (CA) size, which can help in sizing both the extended FOV 215 and the width of the seams 600, and also assist in managing lens element and lens housing manufacturing tolerances. The amount of front color is determined by both the design of the first and second lens groups of the objective lens, and the balance sought in controlling lateral color contributions from the entire objective lens. A reduction in front color can be enabled during a coherent lens design effort of an objective lens and imaging relay combination by relaxing the lateral color targets to the intermediate image (e.g., image plane 360), while compensating for the increased lateral color aberration during the design of the imaging relay 400, such that the final lateral color to a secondary image plane 410 is also satisfactory. It is note that in an imaging system, lateral color can often be reduced to a width of several microns at an imaging plane (e.g., ≤10 mm for visible light). Alternately, lateral color is typically reduced to ≤1.5 pixels width, and preferably to ≤1 pixels width. In the case of a system with a monochrome imaging sensor, such as the Teledyne 67M, the target width would be ≤2.5 microns (a pixel width), but for that same system with a Bayer filtered sensor, the target would be ≤5 microns. Optically coherent optimization of telecentricity can be similarly beneficial, in relaxing the performance to the intermediate image plane 360 while meeting a more demanding specification to a secondary image plane 410.

As yet another aspect to designing an optically coherent objective lens and relay combination, the design of the initial field lens elements 430 in the relay system can be advantageously targeted to both keep the imaging beam size reduced to fit within openings on both sides of the hollow center of a nexus internal frame 800. Use of field lens elements 430 can also improve the image quality to a secondary image plane 410 and help reduce the complexity of the overall relay optical design. Additionally, as part of the approach for designing an optically coherent lens, the lens elements of the third of eyepiece-like lens element group 367 of the objective lens 320 and the field lens elements 430 can be designed in combination to provide an improved image of the initial aperture stop 355 to a secondary aperture stop 455. As these are aperture stop planes, rather than image planes, performance can be benchmarked in waves of aberration. In most systems, aberration quality at an aperture stop is of much less concern compared to aberrations at an image plane. However, in some applications, such as those in which an active wavefront modulating device is used, such as for atmospheric turbulence correction, limiting the aberrations at or near an internal stop plane (e.g., secondary aperture stop 455) can be valuable. As an example, a useful target can be to limit wavefront aberrations near an aperture stop to several waves or less (e.g., ≤8 waves).

FIG. 15A depicts a variation of the optical system of FIG. 9, for a combination of an optically coherently designed objective lens 320 and relay optical system 440, further including a beam splitter 460, that splits the incident image light 425 into separate imaging paths 465, each of which have focusing optics 470 that help enable optical imaging to the respective images planes (410 and 415). The beam splitter 460 can be an optical plate (as shown), or a prism type component, including an x-prism that can simultaneously split light into three light paths 465 and thus enable simultaneous use of three different sensor types. An imaging relay system can also support more than one beam splitter within it. Depending on the system specifications and the sensors provided at the image planes, the beam splitter 460 can split light on the basis of proportional intensity, polarization, wavelength or spectrum (e.g., a dichroic prism), spatial or angular filtering, or a combination thereof. Likewise, depending on the differences between the optical sensor at the secondary image plane 410 versus that at the tertiary image plane 415, the respective focusing optics (470A or 470B) can have different optical designs. For example, if the optical sensor at the tertiary image plane 415 has a different pixel size or resolution, or overall sensor size, than does the sensor at the secondary image plane 410, then the respective focusing optics 470B and 470A can have different designs to help fulfill different performance goals, including matching the two imaged fields of view to be co-aligned to the system optical axis and nominally have the same size. The focusing optics 470 of a light path 465 can also provide a zoom or focus correction capability, so that the optical magnification and focusing can be dynamically changed. These different needs can occur for a variety of reasons. For example, both optical sensors can be CMOS imaging sensors, but one may support higher optical resolution than the other, or one may detect color signals (e.g., with a Bayer filter) and the other monochrome signals. Spatio-temporal dithering of an image sensor laterally within an image plane can also be used to increase the effective sensor resolution. As another example, the objective lens 320 and imaging relay 400 can be designed to support imaging an enlarged spectrum, such as including both visible and infrared (IR) light, and then the beam splitter 410 can separate the visible and IR light from each other to then transit different imaging paths 465A or 465B. The respective image sensors in these light paths 465A,B can then support different specialized spectrums with different performance specifications, such as sensitivity, temporal response, and resolution. For example, an IR sensor such as a micro-bolometer can be used.

The general configuration of FIG. 15A provides the advantage that each camera channel 320 in an improved low-parallax panoramic multi-camera capture devices 300 can be equipped to co-axially detect image light for at least two different sensing modalities. When this channel architecture is applied to multiple camera channels 320, then device 300 can provide multi-modality sensing over a wide field of view and be used to increase situational awareness of objects or events within an environment. For example, if a device is being used to detect a moving vehicle, whether ground based or airborne, it can be advantageous to have the camera channels simultaneously image both visible and IR light. The IR light image can be used to detect and locate a thermal signature of a vehicle or of another object in the environment, while the visible light image can be used to help identify the vehicle or object. To enable traffic monitoring, the improved low-parallax panoramic multi-camera capture devices 300 can be mounted on the vehicles, or in the environment, or both.

As a specific such example, one of the optical sensors located at or near an image plane (410 or 415) can be an event sensor or neuromorphic sensor, including devices available from Oculi-ai (Fris Inc., Columbia, Md.) or from Prophesee (Paris, Fr.). These devices are much faster (e.g., 10,000 fps) and sensitive (e.g., 120 dB) than standard CMOS or CCD imaging sensors, which makes them useful in detecting sudden events or fast-moving objects in a scene or environment. These devices can also be IR sensitive, which helps in detecting moving vehicles, such as airborne or ground based cars, aircraft, drones, missiles, or other concerns that relate to improved situational awareness. However, at present, these sensors have large pixels (e.g., 5-20 microns) and lower resolution (e.g., ≤1 MP) when compared to standard imaging sensors. Thus, it can be advantageous to provide improved devices 300 with multiple camera channels with imaging relays and a beam splitter (e.g., FIG. 15A), and with dual imaging and event sensors, to provide co-aligned WFOV sensing of an environment. These sensors can be operated simultaneously to correlate, compare, and contrast the image data that they collect. The imaging sensor can also be operated at low power or performance until an event sensor detects a triggering event and higher resolution imaging is needed.

Optical configurations such as those of FIG. 15A may also include a second beam splitter (not shown) at or near or prior to the secondary aperture stop 455, to direct image light onto an optical sensor. An earlier interception of the transiting image light in the relay optical path can make it easier to provide customized beam shaping or focusing optics (470) to a second image sensor than waiting later in the optical path (as shown). Alternately, beam splitting near the secondary aperture stop 455 can allow an optical wavefront sensor to be included. Likewise, the beam shaping or focusing optics (470) to a secondary optical sensor can be more elaborate than shown and provide a further relayed image of the aperture stop 355 (e.g., a tertiary aperture stop (not shown)). As suggested previously, the relay or beam shaping optics to a second optical sensor can include an optical zoom. An optical zoom can include an axial step zoom to shift optics between at least two fixed zoom settings (e.g., dual view), a continuous axial optical zoom, a varifocal or focus compensated zoom, or a tumbler type zoom that uses a mechanism to substitute one or more alternate sets of optics into the relay optical path or a beam split light path 465, in exchange for a prior set. When zoom optics are used, it can also be desirable to be able to move the smaller zoomed FOV around within the larger FOV that is imaged by a camera objective lens 320. Beam steering optics, such as a pair of crossed galvanometers (e.g., galvo scanners) or a dual axis scanning mirror device (e.g., a 2D MEMs device, such as from Fraunhofer IPMS) can be included in the beams shaping optics for this purpose. As another variant, for applications involving imaging through a significant distance (e.g., miles) of Earth's atmosphere, atmospheric turbulence can degrade image quality. To correct for this, the beam shaping optics to a sensor can further include adaptive optics, such as a wavefront modulator or atmospheric turbulence correction device (e.g., a deformable mirror device from Alpao, Montbonnot, France).

The relay optics can also be designed to collect image light from the intermediate image plane in either a telecentric or non-telecentric manner, and likewise present image light to the remote image sensor in a telecentric or non-telecentric manner. The relay can also be double telecentric, which means simultaneously telecentric to both the intermediate image and remote sensor planes. Either the first aperture stop 355 or a secondary aperture stop 455 can be the limiting stop for this system. As an example, the first aperture stop can be the limiting stop, and the secondary aperture stop can be slightly oversized, but can still contribute to vignetting stray light and improving detection contrast.

As yet another aspect, the design of the imaging relay optics, whether beam splitters 460, optical zooms, or other devices, are included or not, can complicate the opto-mechanical or mechanical designs that support the relay optics, beam shaping or zoom optics, sensors, and other hardware (e.g., see FIG. 14). To aid the optical performance, the opto-mechanics can include zoom mechanisms, active focus shift mechanisms or athermal focus correction designs, or sensor dithering mechanisms, or other devices. As compared to the example in FIG. 14, which has the relay systems 925, sensors and their housings 930, splayed out, it can be mechanically advantageous to have the relay imaging paths turn parallel to each other. The imaging relay optical designs can be lengthened to facilitate the addition of mirrors or prisms to turn the relay or beam split optical paths. Alternately, for mechanical or packaging reasons, it can be desirable to shorten the imaging relay optical path(s). The relay optical designs can be optimized to enable that, including by using a reverse telephoto design approach.

FIG. 15B depicts another example of an optical design in which an objective lens or camera 320 that is designed for an improved low-parallax multi-camera panoramic capture device 300 is optically coherently paired with a relay lens system 400 along optical axis 385. In this example, the objective lens 320 is sized to be a hexagonal camera channel with a 20.9 deg. half-FOV at mid-chord and a 23.8 deg. half-FOV at the vertices, as needed for an improved low-parallax panoramic multi-camera capture device 300 based on a regular truncated icosahedron. This objective lens has an 83.5 mm on axis length with a front lens diameter of 87 mm, and it operates at f/2.8 to a 10 mm wide image at intermediate image plane 360. Performance wise, it provides 0.5 mm front color, +/−3.5 microns of lateral color (±1.5 pixels) , <2% distortion, and MTF >60% at 140 cy/mm. The relay optical system 400 operates at 2× magnification, enabling a Teledyne 67M sensor to be used at a secondary image plane 410. This combination of objective lens and relay provides <2% distortion, RI >70%, total lateral color of ˜2.5 microns or ˜±0.5 pixel, and a polychromatic (for Bayer filtered sensor) MTF at 100 cy/mm of ˜50%. The objective lens 320 provides a telecentricity of 5 deg at the intermediate image plane 360, but the two-lens combination provides only 1.4 deg. at the secondary image plane 410. The parallax of this example objective lens is reduced to ≤0.4 arc minutes in green over the imaged field.

As compared to the examples of FIG. 9 and FIG. 15A, the objective lens 320 of FIG. 15B, which is working with a smaller FOV (e.g., 23.8° instead of 37.4° provides better imaging performance to a larger intermediate image plane 360, which in turn better supports a large sensor and higher resolution at a secondary image plane 410. In addition, with coherent optical optimization, both lateral color and telecentricity at the intermediate image plane 360 have been somewhat increased or sacrificed to help both front color at the outer lens element, and lateral color and telecentricity at the secondary image plane 410. This design trade-off can be taken further, to drive front color (e.g., ≤0.1 mm), or chromatic spherical aberration of the entrance pupil (e.g., ≤0.5 mm) under tighter control, while allowing further image quality degradation to the intermediate image plane 360 that is remedied to the secondary image plane 410 by a coherent optical design of the objective lens and relay. Reducing front color in turn helps enable reductions in the width of the gaps or seams 600 between imaging channels.

As discussed previously, FIG. 4 depicts the basic construction of a LIDAR system 1000, in which a laser light source 1010 emits laser light (λ). This light can be configured for optical scanning 1015 by scanning optics or laser source construction or a combination thereof. Emergent laser light from a first optical system whether scanned, swept, or flash illuminated, can be modified by further illumination optics 1020, to then illuminate a portion of an environment 1070 that can have a set of objects (1071-1073) therein. The laser light (λ) can then be scattered, reflected, or diffracted from these objects, and a portion of that redirected laser light (λ′) can then be collected into a second optical path, including optics 1025 and optical sensor 1030. The resulting signals can be examined by processing electronics 1040 to detect object size, depth or position, and to determine and track the relative positions of such objects in a scene or environment, thus providing situational awareness of that environment. As an example, the HDL-64E1 is a 3D scanning LIDAR from Velodyne (Morgan Hill, Calif.) that uses 64 separate lasers, vertically arranged to cover from −24.8° to +2° at approximately 0.4° increments, while rotating the laser array to scan a 360° horizontal field of view (FOV) at 0.09° incremental postings. Alternative LIDAR technologies are being developed, which are smaller, and more readily integrated into other types of optical systems, and thus which may have the potential to provide enhanced situational awareness for a wider range of applications. These technologies include optical phased arrays (OPAs), flashed VCSEL laser devices and arrays, and scanning systems using micro-electronic mechanical systems (MEMS).

As compared to the neuromorphic or event sensing technologies which passively detect light coming from (e.g., ambient scattered light or emitted (thermal) light) coming from objects in an environment, LIDAR systems actively emit light into the sensed environment, and then detect return light. Many LIDAR devices sense the time of flight (TOF) of the return light so as to determine the relative position of an object, while others use Frequency Modulation Continuous Wave (FMCW) frequency modulation technology to detect beat frequencies or Doppler shifts between the emergent and return light. The latter approach is more accurate, but also more difficult to implement. Whereas, with Flash LIDAR, a scene can be illuminated with a single flash, and a two-dimensional array of tiny sensors detects light as it bounces back from different directions, and the time delays for a whole pixel matrix can be measured simultaneously. Flash LIDAR systems can operate without scanning, although there are hybrid scanning Flash systems. Flash LIDAR may best enable sensing for automotive and other temporally dynamic applications, as compared to scanning technologies that require use of complicated mechanical or opto-electronic (e.g., optical phased arrays (OPA)) devices that operate at reduced effective frame rate. However, whether one or multiple Flash LIDAR sources are used, the instantaneous laser power requirements are higher and the eye laser safety concerns for pulsed laser exposures can be more difficult.

In scanning systems, beam steering is usually provided with a mechanical system like a rotating mirror, which can make the system large, costly, and unstable. Recently, microelectromechanical system (MEMS) solid state mirrors have been employed to reduce size and cost, but there can be a trade-off between the size, beam divergence (or resolution), and speed. Therefore, complete non-mechanical (solid-state) devices have been sought, and optical phased arrays (OPAs) fabricated by using a silicon (Si) photonics, complementary metal oxide semiconductor (CMOS) process, have been developed extensively for this purpose. However, there are still many challenges for OPAs in the large-scale integration of optical antennas, the complicated and power-consuming optical phase control, and the trade-off between the steering range, resolution, and efficiency. As OPA devices can have light emission and detection integrated onto one device, they can be used in systems with shared optics for both illumination and light collection.

As discussed previously, a low parallax camera or objective lens 320 of the type of FIG. 2A or FIG. 8 can be used in an improved low-parallax panoramic multi-camera capture devices (300) to provide enhanced situational awareness, including by using multiple sensor modalities, including LIDAR or laser range finding technologies. There are several possible configurations of laser range finding or LIDAR optics that can be combined to be coaxial with an imaging lens, including for a camera objective lens for an improved low-parallax panoramic multi-camera capture device (300).

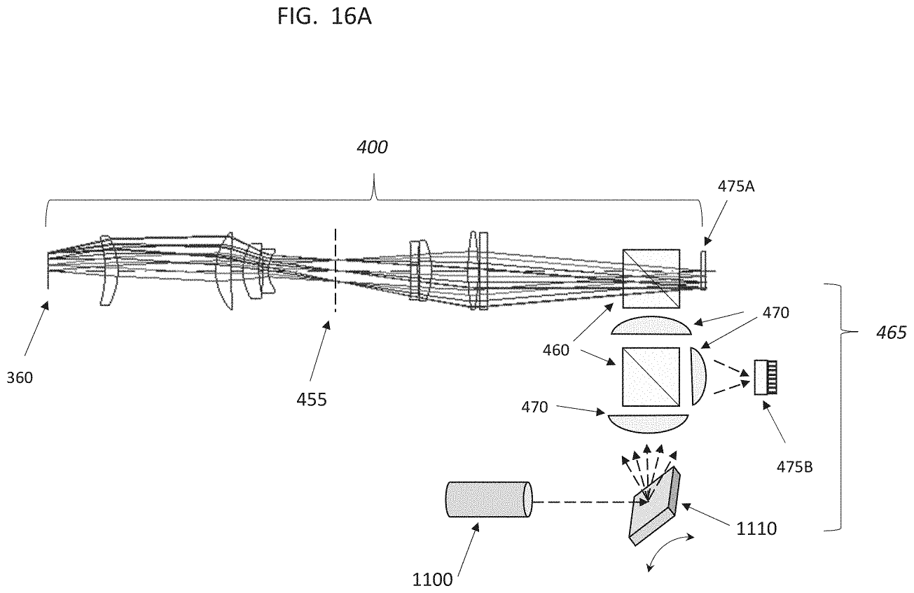

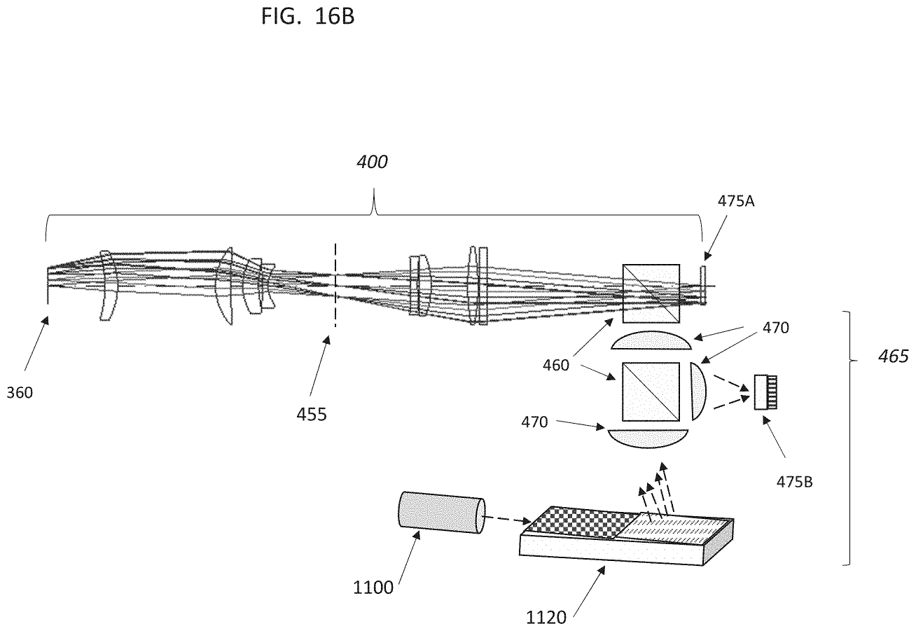

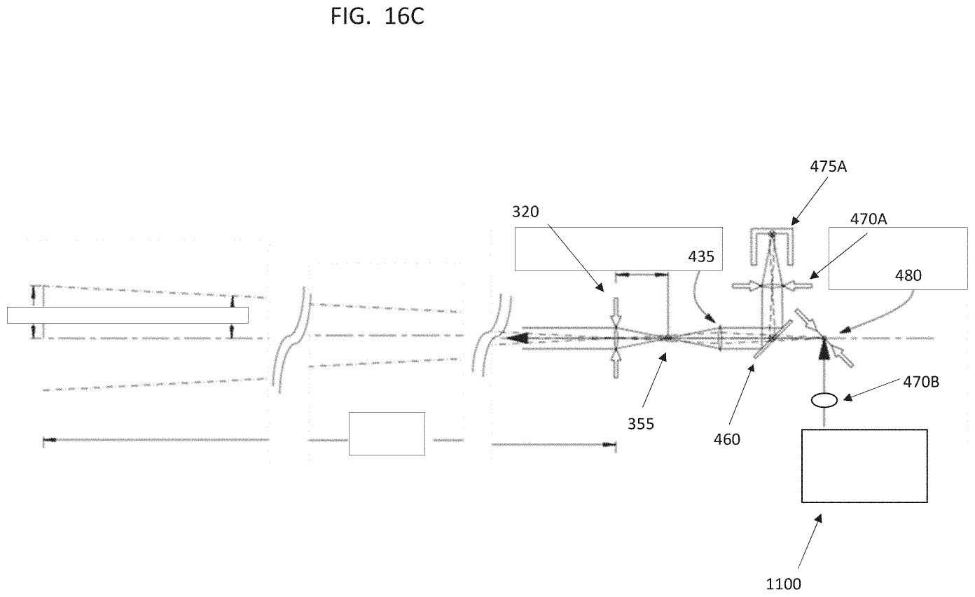

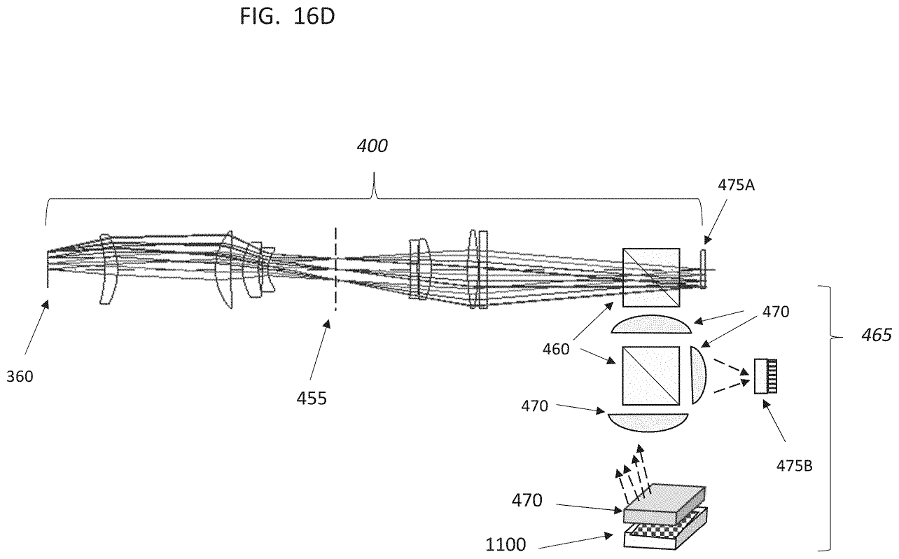

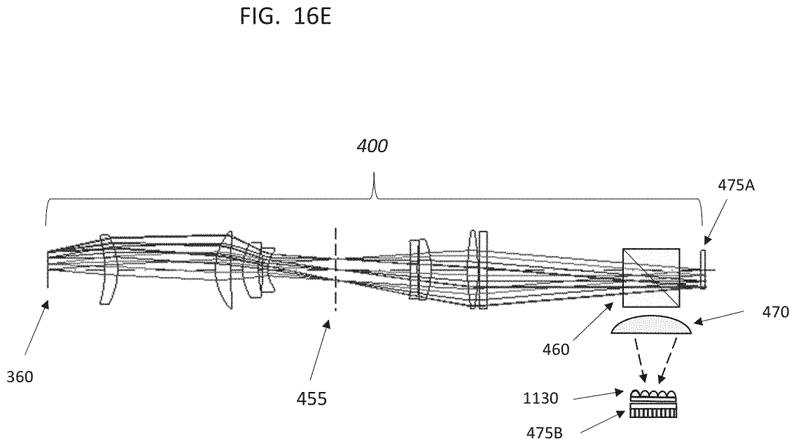

As a first example, FIG. 16A depicts a relay optical system portion of the type of FIG. 15A, but which further includes a laser range finding subsystem having a MEMS mirror. In this example, light from a laser source 1100 (e.g., at 905 nm), which can be directly or indirectly modulated to provide a light pulse for time of flight distance sensing, is directed onto a MEMS mirror device 1110. Candidate MEMS mirror devices can be a 1-axis or dual axis scanning device provided by vendors such as Preciseley Microtechnology Corp. (Edmonton AB, CA) or Fraunhofer IPMS (Dresden, Del.). Preferably a dual axis MEMS mirror is used to scan in both θx and θy, but a pair of offset single axis devices can also be used. The MEMS mirror device can also have multiple micro-mirrors, and even be a linear or area device, including a DLP or DMD type device from Texas Instruments. The range finding laser light can then be directed through beam shaping optics 470 and into the common light path that is shared with the image light that is being directed to an image sensor 475A. This light can then transit the relay optical system 400, and the camera objective lens (not shown) to be directed out into an environment, where it can illuminate objects within a FOV or scene. Then some of this illuminating laser light that has back reflected, back scattered, or diffracted from these objects can be collected by the objective lens, and then be directed through the relay optical system 400 and into the secondary optical path, to be incident to a laser range finding or LIDAR sensor 475B. Depending on the system configuration, the sensor can be a single-photon avalanche diode (SPAD) array, or detector or sensor array, including a SPAD array, a Geiger Mode Avalanche Photo Diode (GmAPD), or a Multi-Pixel Photon Counters (MPPC). Such devices are available from suppliers including Fraunhofer, Excelitas, or Hamamatsu. The sensor can also be an event or neuromorphic sensor from Oculi-ai or Prophesee. The resulting laser range finding data can then be assembled into a point cloud, to create an IR image and distance map of the location of objects in a scene. This data can then be correlated or compared to the visible image data that is captured by the image sensor 475B, thus enabling objects to be both readily located and identified. Because the LIDAR system and the visible optical image capture system can operate simultaneously in a nominally coaxial manner, the LIDAR and visible image data can be robustly aligned and calibrated, one to the other.

The MEMs mirror approach of FIG. 16A has the advantage that it can provide dual axis scanning while using a single laser source operating in a narrow wavelength range (e.g., ≢λ≤6 nm). The scan resolution, which is limited by the laser pulse rate and the MEMs mirror scan rate and duty cycle, can be high (e.g., approaching low to mid camera resolution levels). However, the MEMs mirror devices can be sensitive to external vibrations.

As a second example, FIG. 16B depicts a portion of an alternate system in which a laser range finding or LIDAR device is combined with a relay optical system and a camera objective lens to enable an improved low-parallax panoramic multi-camera capture device (e.g., the device 300). In this case, light from a laser (e.g., 1450-1600 nm) is coupled into an optical phased arrays (OPA) 1120 which then provides a scanning laser beam. OPA based LIDAR scanning technologies and systems are being developed by companies including Quanergy (Sunnyvale, Calif.), Analog Photonics (Boston, Mass.), and Voyant Photonics (New York, N.Y.). Typically, input laser light from a fiber coupled source laser is fed onto an input waveguide. That light is then split into a series of secondary waveguides, where it encounters a series of phase shifters. The phase of the light passage through the individual waveguides is then modified by modulating micro-heaters that locally modulate the index of refraction within a few microns of the waveguide. These waveguides run parallel for a modest distance, and then terminate in a low roughness plasma etched surface, from which light is emitted.

An optical phased array 1120 includes multiple optical antenna elements that are fed equal-intensity coherent signals. A phased array is a row of transmitters that can change the direction of an electromagnetic beam by adjusting the relative phase of the signal from one transmitter to the next. With this variable phase control, and if the transmitters all emit electromagnetic waves in sync, the beam will generate a far-field radiation pattern and point it in a desired direction. For example, the beams can be sent out straight ahead—that is, perpendicular to the array.

To direct the beam to the left, the transmitters skew the phase of the signal sent out by each antenna, so the signal from transmitters on the left are behind those of transmitters on the right. To direct a beam to the right, the array does the opposite, shifting the phase of the left-most elements ahead of those farther to the right. The second dimension of aiming can be obtained by varying the frequency (or wavelength) of laser light and then passing the light through a grating array that—like a prism—directs light in slightly different directions depending on its “color,” For example, the IR laser can be tuned during use to emit laser light between about 1475 nm and about 1640 nm. Depending upon the technology and the company, beam steering has been demonstrated within a 40-50° FOV and with beam divergences as small as 0.02-0.08°.

A goal is to provide clean output beams that illuminate a scene in an intended direction, without crosstalk (cross illumination). But the emitted beam can have side lobes, when the antennas (emitters plus waveguides) are spaced greater than half a wavelength apart. The presence of residual side lobes depends on the waveguide spacing and tolerances, and the wavelength of the transiting light.

As before, scanning laser light can be directed into and through a relay optical system 400 and a low parallax camera objective lens (not shown) to illuminate one or more objects in an environment. A portion of reflected light from object space can then travel the same path traversed after emission—in reverse. As shown in FIG. 16B, the system can have a non-monostatic configuration, with the reflected light directed onto a nearby detector or detector array 475B, such as a GmAPD, or MPPC, or event sensor. Another possible system configuration includes two separate OPA switched tree array distribution networks, one for transmit (send) and the other for the receive signals. Yet another configuration has the reflected light traveling a reverse path so as to be collected by the same OPA device 1120 from which the light was emitted, and to a same emitter as transmitted, directed back through the switched tree array to a 2×2 switch (redirector), where it is directed to the coherent detector for detection. This is called a monostatic or bidirectional configuration. In any case, as the signals are detected, point cloud data sets can be collected to measure the presence and location of objects in the surrounding environment. This point cloud data can the be used in combination with image data collected by sensor 475A.

As compared to the MEMS approach, the OPA approach can be completely solid state without mechanically moving parts. As it also uses FMCW or Doppler distance sensing, the location of objects can be determined more accurately, and further, the velocity and acceleration of moving objects can be determined. But the OPA approach is more complicated, relative to requiring the use of a fiber coupled laser and more complicated drive and processing electronics. As the OPA approach also captures distance data at a low angular duty cycle, due to diffraction, the angular resolution can be low.

A MEMS or OPA LIDAR scanning system, as illustrated conceptually in FIG. 15A and FIGS. 16A and 16B, can be designed as shown conceptually in FIG. 16C. A LIDAR laser 1100 can provide light via beam shaping optics 470B and a mirror 480 so as to work with relay optical elements 435 to focus laser light near the objective lens aperture stop 355, such that nominally collimated light beams can then emerge from the objective lens 320 with a beam waist at, or near, or somewhat beyond the outer surface of the outermost compressor lens element of the objective lens 320. As a result, the LIDAR sub-system, through the objective lens, scans an environment, such that a single pulse represents a single chief ray. A mask at the aperture stop 355 of the objective lens 320 or the relay optical system (a secondary aperture stop 455) can also be “color” dependent, using spatially variant filters to provide a different stop diameter for IR light than for visible light.

As a third example, FIG. 16D depicts a portion of an alternate system in which a flash laser range finding or LIDAR device is combined with a relay optical system 400, and a camera objective lens (not shown), to enable an improved low-parallax panoramic multi-camera capture device (300). Solid state flash LIDAR is being enabled by vertical-cavity surface-emitting laser (VCSEL) technology (1100). For example, IR VCSEL devices are available from companies including Trilumina (Albuquerque, N.Mex.) and Finisar (Sunnyvale, Calif.). two dimensional VCSEL laser arrays can have 5,000 or more addressable laser emitters providing discrete laser beams, where the return light can then be collected onto a detector such as single-photon avalanche diode (SPAD) array (475B). But flash LIDAR, while simple to develop, can waste laser power sending light to locations that the detectors are not looking. Whereas, with “multi-beam” flash LIDAR can be selectively operated to provide laser light (e.g., 850 nm or 940 nm) in directions where the detectors are looking. The laser light emitted by VCSELs can be directionally controlled by various means to fill a scanned FOV, including with beam shaping optics such as lenslet or micro-optical arrays, or by providing spatially variant epitaxial growth at the top of the laser cavities. The multi-beam flash devices can also function as hybrid LIDAR cameras, capturing low to mid resolution infrared images of the environment. The VCSEL lasers are also much cheaper than the 1550 nm fiber lasers used in many pulsed LIDAR (e.g., OPA) systems.

While LIDAR can quickly provide position and velocity information for objects in an environment, it can be confused by complicated structures or objects having windows or mirrors. Confusion from light redirections from windows and mirrors are a recognized problem for LIDAR systems, whether the LIDAR is used for autonomous vehicle navigation, mapping or photogrammetry, or non-vehicular robotic navigation. In particular, light reflections or refractions at these surfaces can confuse a LIDAR based detection system, by causing spurious noise (e.g., from light scatter at a contaminated optical surface), or providing overly strong return signals, or by deflecting light in expected directions. In the latter case, a mirror or window can be invisible to a LIDAR system, such that is absent from the resulting point cloud. Light redirections can also cause other objects, located behind or near a mirror or window, to be either invisible, or to be detected at incorrect locations.

Published literature in the LIDAR field suggests that confusing reflections caused by windows and mirrors can be compensated by for detecting the presence or location of these objects by detecting the optical direction and intensity differences off of these objects as compared to reflections off other objects. Mirror or window reflections can be compared to reflections from diffuse or specular reflecting objects, to detect “jump edges” or frames, or to look for reflection symmetries or asymmetries. These mirror and window detection methods rely on novel algorithms to process the incoming sensed environmental data. There are also approaches for reducing the effects of window and mirror reflections that rely on dual sensing, where a laser ranging or LIDAR system is used in combination with another detection technology (e.g., use of cameras, sonar, or ultrasound). In general, use of dual sensing often solves the object confusion problem, whether for mirrors or windows or other complex objects, but it costs more, can be more time consuming, and may not always resolve object ambiguities, nor be acceptable for all position or depth sensing applications. Moreover, in the case of dual sensing approaches, there is an added burden to accurately overlay or superimpose, compare, and prioritize, the data from the two modalities.

In the above examples, a channel of an improved low-parallax panoramic multi-camera capture device (300) has beam splitting optics (and likely relay optics 400), an image sensor, and a laser range finding or LIDAR system and sensor, which are nominally functioning through a partially common optical system (e.g., at least a portion of the camera objective lens 320). While the camera objective lens system is typically designed to image visible light with low parallax or perspective error and high image quality, the range finding systems generally use IR laser light which then needs to emerge from the objective lens to illuminate an appropriate field of view with proper beam control. Nominally the FOV scanned by the LIDAR system matches, or is slightly larger than, the FOV imaged by the camera objective lens system Also nominally, to help angular resolution, a beam waist for a scanning laser beams is positioned at or near the exit face of the outermost compressor lens element of the objective lens 320, if not a few feet beyond it, into the surrounding scanned environment. To help the overall system performance, the camera objective lens 320 can be designed to both image visible and IR light. However, the beam shaping optics 470 in the secondary optical path for IR depth sensing can be designed to correct or compensate for the IR specific chromatic aberrations of the objective lens 320. Depending on the type of LIDAR system, whether MEMs, VCSEL Flash, or OPA based, the design configuration of the beam shaping optics will vary relative to FOV mapping, beam waist control, and chromatic correction of the IR light through the objective lens (and relay optical system).

The present approach for an improved low-parallax multi-camera panoramic capture device 300 can co-axially supporting dual sensing modalities, relative to viewing a surrounding environment, with designs with or without relay imaging optics. Certainly, designs with combining low parallax objective lenses 320 paired with relay optics (e.g., FIG. 15) can more readily include a various or multiple sensing modalities, combining a LIDAR technology (e.g., FIGS. 16A-16D) with standard visible or IR imaging sensors. This enables co-aligned LIDAR enabled depth point cloud data to be used in combination with image data, in real time, with low parallax, from multiple camera channels 320 viewing a wide FOV. An imaging sensor, whether a standard CMOS or CCD device or IR sensitive array device, or neuromorphic or event sensor device, or a combination thereof, can act as a triggering device, to passively detect an object or event in an environment, which is further evaluated using LIDAR captured point cloud data. The LIDAR system can be on standby, or in a low power operating mode, until a triggering event occurs. In the case of a directionally controllable LIDAR, such as some Flash VCSEL systems, the real-time directional control can be informed by the image data collected by the other sensor. Pairing with an event or neuromorphic sensor can be particularly advantageous, as these devices are much faster and more light sensitive than standard imaging sensors. This approach for pairing co-axial dual or multi-sensing modalities with LIDAR can also help address the previously discussed problems for LIDAR in dealing with confusing light reflections from windows and mirrors.

To improve signal to noise for depth sensing, the overall optical system will also have to be designed to suppress chromatic crosstalk. This means that the visible optical light to the image sensor 410 can have additional filtering, beyond the beam splitter 460 and the normal IR cut filter, to block IR light. Likewise, the secondary IR optical path can have extra filtering, beyond just the beam splitter 460, to block out visible light. These extra filters can be light absorbing filters or dichroic filters. It is also noted that the AR coatings on the objective lens 320 and the relay optics 400 will have to be designed to efficiently transmit both visible light and IR depth sensing light. In the latter case, this helps to both improve efficiency and prevent spurious back reflections from being interpreted as signals. Filtering by pulse timing can also help, as back reflections from within the optics will occur much more quickly than those from objects in the environment.

As shown in FIG. 16E, an improved low-parallax panoramic multi-camera capture device (300) can also have light field based depth sensing optics. Light field detection technologies have been developed by companies such as Lytro and Raytrix. In particular, in the present approach, light field detection optics can be provided via a relay optical system and a beamsplitter. The light field sensor is essentially a standard imaging sensor (e.g., 100 px/deg), augmented with a light field optics (e.g., micro-lenslet arrays or pinhole cavities) so that visible image light is directed onto one or more sensing pixels within a sub-array of sensing pixels. From the resulting pixel data, information about the local directional orientation of the visible image light can determined, to provide indications about the depth or position of objects within a scene. As with the laser range finding or LIDAR examples, the normal visible 2D image data collected by the image sensor, and the light field data, can be registered and compared, to improve light field image data processing, and to associate position data with specific objects.

In the example systems of the present approach, in which a low-parallax camera or objective lens 320 is combined with an imaging relay optical system 400, the relay optics have been depicted as a lens system consisting of a plurality of lens elements (e.g., see FIG. 15A). However, the relay optics can also be designed as a reflective system, using a plurality of curved and plane mirrors with metal or dielectric coatings. The relay optics can also be catadioptric and consist of a combination of refractive lens elements and curved mirrors. Alternately, the relay optics can comprise, or include a coherent fiber optic bundle to transfer image light to one or more optical sensors. As a particular example, a device design with shortened image relays could pass several image light beams through the shared hollow space in the center of a nexus internal frame 800, but then focus or image the light onto the input face of a fiber optic array. A coherent fiber optic array or bundle, in which the relative 2D arrangement of the optical fibers are maintained at both the input and output faces, could then transfer the image light to a distant imaging sensor for detection. Alternately, fiber optic bundles can be used in the systems of FIG. 11 and FIGS. 12A and 12B to transfer the image light to remote sensors without using imaging relay optics.

As another variation, an improved low-parallax panoramic multi-camera capture device 300 can have a combination of camera channels that include imaging relay optics (e.g., FIG. 15A) and mechanics (e.g., FIG. 13) and others that do not (e.g., FIG. 8 and FIGS. 12A and 12B). For example, a device 300 can have the primary camera channel and the secondary ring of camera channels each equipped with an imaging relay, single or plural sensor modalities, and appropriate optimized optics to support imaging or focusing light to the different optical sensors. Simultaneously, the outer or tertiary ring(s) of camera channels 320 can directly image light to an optical sensor located at their internal image planes 360. As another variation, the camera channels on one side of the device (e.g., left side) can be equipped with both objective lenses (320) and imaging relays 400, while the camera channels on the other side of the device (e.g., right side) have camera channels 320 that directly image light to an optical sensor located at their internal image planes 360. Although the emphasis has been on devices 300 with generally spherical configurations (e.g., FIG. 12A,B) or hemispherical configurations (e.g., FIG. 14), the approach is also extendable to other device configurations such as ones with an annular arrangement of camera channels. Additionally, it is note that the present approach can be applied to a single imaging channel system, having a single objective lens 320 paired with an imaging relay optical system 400, and one or more sensors at secondary image planes. For example, an event sensor or a LIDAR system could be along one optical path off a beam splitter, while a high-resolution imaging sensor is off a second optical path. In this case, the dual sensors can be co-axially aligned in imaging through the objective lens from the environment, while the objective lens is designed to control perspective errors (e.g., FIG. 5F). For a single lens system, the outer compressor lens element of the objective lens need not have a polygonal shape but can instead be circular or have a free-form contour shape.

Environmental influences can also cause a multi-camera capture device to be heated or cooled asymmetrically. The previously discussed kinematic mounting or linkage of adjacent camera housings (e.g., see FIG. 11 and FIGS. 12A and 12B) for an improved multi-camera capture device 300 can help reduce this impact, by trying to deflect and average the impact of mechanical stresses. For example, it can be additionally beneficial to provide channels or materials to communicate or shift an asymmetrical thermal load to be shared more evenly between or by cameras 700 and their housings 730. With respect to FIGS. 12A and 12B, this can mean that the spaces around the lens housing 730 and the channel centering hub 750 are provided with compliant but high thermal contact, thermally conductive materials (e.g., Sil-Pad or CoolTherm) to help spatially average an asymmetrical thermal load or difference. However, at the same time, some of the effect of thermal changes, relative to the imaging performance of the camera lenses can be mitigated by both judicious selection of optical glasses and athermal mounting of the optical elements within the lens housing 730. Taken in combination, an effective design approach can be to enable thermal communication or crosstalk between camera lenses and their housings 730 to environmental influences, but to simultaneously isolate the lenses and housings from the sensors and their electronics.

An improved multi-camera capture device 300, and the cameras 320 therein, can also be protected by an optical dome or a shell (not shown) with nominally concentric inner and outer spherical surfaces through which the device can image. A protective optical dome can also be a faceted dome, providing a plurality of outer compressor lens elements, one per camera channel. A dome can also be a hybrid design, with a portion being faceted to provide outer compressor lens elements, and another portion just having concentric inner and outer spherical surfaces. The addition of an outer dome can be used to enclose the nearly spherical device of FIGS. 12A and 12B, or with the nearly hemispheric device of FIG. 14, or for a device an alternate geometry or total FOV. The dome can consist of a pair of mating hemispheric or nearly hemispheric domes that interface at a joint, or be a single nearly hemispheric shell (e.g., for FIG. 14). The optical dome or shell material can be glass, plastic or polymer, a hybrid or reinforced polymer material, or a robust optical material like ceramic, sapphire, or Alon. The optically clear dome or shell can help keep out environmental contaminants, and likewise if damaged, function as a FRU and be replaced. It can be easier to replace a FRU dome than an entire camera 320 or a FRU type outer lens element or outer lens element assembly. The dome or shell can also be enhanced with AR, oleophobic, or hydrophobic coatings on the outer surface, and AR coatings on the inner surface. Although the use of a dome or shell can reduce the need or burden of also using a carrying case or shipping container, such enclosures can still be useful.

Additionally, imaging systems of the type of FIGS. 12A and 12B which includes a multitude of low-parallax imaging lenses of the type of FIG. 8 without an imaging relay, and imaging systems of the type of FIG. 14 that can have a nexus internal frame of FIG. 13 with optics of the type of FIG. 9, can also be used for display applications. In particular, instead of placing an image sensor at the objective lens image plane 360 or at a secondary image plane 410 provided by an imaging relay, a display device can be placed at either of these locations, to create a multi-objective lens projection display system (e.g., as in device 300, but a display system rather than a camera system), that for example, can be used in cinematic theatres, dome theatres, simulators, or planetariums. In each imaging channel, an objective lens and imaging relay system work together to image a display device to a portion of a display screen. An image display device can be an array device with directly addressed pixelated light emitters, that directly emits light, using LEDs (e.g., micro-LED arrays), lasers, super-luminescent diodes (SLEDs), or quantum dots (Q-Dot) devices. An image display device can also be a pixelated light modulator, such as a Liquid Crystal on Silicon (LCOS) device or a Deformable Micro-mirror Device (DMD), that modulates transiting light provided by a separate light source. The array display device, whether a light emitting or light modulating device, can be providing multi-color or single-color modulated light. As these light emitting or modulating devices readily be larger than the image sensor arrays, these devices can be difficult to fit at an imbedded image plane 355 of an objective lens 320 (e.g., FIG. 8 and FIG. 12A,B) within a multi-lens device (300), but a system with an imaging relay 400 can be advantaged because of the additional space. In cases in which three light emitting or light modulating array devices are used, one per color (RGB) per imaging channel (320), image light is typically combined into a common optical path by means of an RGB beam combiner. Thus, the imaging relay approach (e.g., FIG. 15A) is even more valuable for this architecture because of the additional space it can provide for opto-mechanics. Additionally, the display array devices can have demanding cooling needs, and thus require additional mechanical space that the image relay approach can provide. When using such a system, images can be advantageously presented to wide FOV screens with minimal distortion or other image artifacts in the small image overlap regions corresponding to the seams. As an example, for a theatre having a dome configuration, a projection device of this type can be positioned at or near the hemispheric center of the theater, and project image content to a surrounding screen. The projection display device (300) can also be a “quarter sphere” type system that uses a low parallax multi-lens imaging device to project to a combined spherical screen portion that is nominally 180 degrees wide horizontally and 90 degrees tall vertically. Some display pixels of the array display devices used in the peripheral display channels of the display device (300) can be kept off, so as to provide smooth edges along the outer contour of the overall projected image.

Although this discussion has emphasized the design of improved multi-camera image capture devices 300 for use in broadband visible light, or human perceivable applications, these devices can also be designed for narrowband visible applications (modified using spectral filters), ultraviolet (UV), or infrared (IR) optical imaging applications. An improved low-parallax panoramic multi-camera capture device (300) for infrared imaging can support near-IR (NIR) or short-wave IR (SWIR), mid wave IR (MWIR), or long wave IR (LWIR) imaging, and multispectral imaging or hyperspectral imaging that can also include visible imaging. Polarizers or polarizer arrays can also be used. Additionally, although the imaging cameras 320 have been described as using all refractive designs, the optical designs can also be catadioptric, and use a combination of refractive and reflective elements.

What is claimed is:

1. An imaging system for use in a low parallax multi-lens imaging device, the imaging system comprising:
an objective lens comprising a first lens element group having an outer lens element, a pre-aperture stop second lens element group, and a post aperture stop third lens element group, wherein the first lens element group, the second lens element group, and the third lens element group direct incident light within a field of view towards a first image plane as an image; and
a relay optical system configured to magnify the image onto a secondary image plane as a magnified image,
wherein the objective lens is configured to direct incident light that enters the outer lens element of the first lens element group such that projections of chief rays included in the incident light converge toward a low-parallax volume located behind the first image plane,
wherein the objective lens configuration provides a front color artifact and a first lateral color artifact at the first image, and
wherein the relay optical system reduces the first lateral color artifact such that the magnified image has a second lateral color artifact lower than the first lateral color artifact.

2. The system as in claim 1, wherein parallax is corrected by limiting a transverse component of a spherical aberration at a plane that favors image light from peripheral fields.

3. The system as in claim 1, wherein parallax is corrected by limiting a longitudinal width of the low-parallax volume.

4. The system as in claim 1, wherein the field of view of the objective lens and a magnification of the relay optical system provide a target optical resolution at the secondary image plane.

5. The system as in claim 1, wherein the front color is limited to an extent of less than or equal to about 0.5 mm.

6. The system as in claim 1, wherein the design of the objective lens and the relay optical system are further designed to sacrifice one or more optical performance attributes, including spherical, coma, astigmatism, field curvature, distortion, chromatic aberrations and telecentricity, at the first image plane so as to benefit performance at the secondary image plane.

7. The system as in claim 1, wherein the relay optical system further includes a beam splitter configured to split incident light into a plurality of lights paths and a plurality of optical sensors, individual of the optical sensors being associated with one of the plurality of light paths.

8. The system as in claim 7, wherein the relay optical system further includes one or more of zooming optics, focusing optics, galvo scanners, wavefront modulators, or optical filters.

9. The system as in claim 7, wherein the plurality of optical sensors comprise at least one of a visible image sensor, an infrared image sensor, an event sensor, a neuromorphic sensor, or a light field sensor, and wherein a field of view for one of the plurality of optical sensors substantially matches a field of view for the image sensor, with respect to a field of view captured by the objective lens.

10. The system as in claim 7, wherein the relay optical system further includes a depth sensing optical system including a laser range finding system including both a laser light source, one of the plurality of optical sensors, and beam shaping optics.

11. The system as in claim 10, wherein the laser light source comprises a directionally controlled flash laser light source.

12. The system as in claim 10, wherein the depth sensing system comprises at least one of a MEMS mirror device that provides directional scanning of the laser light or an optical phased array to directional scan the laser light in at least one scan direction.

13. The system as in claim 10, wherein the beam shaping optics direct the depth sensing laser light to a focus at or near an aperture stop of the objective lens system.

14. The system as in claim 10, wherein the camera is designed to image visible light, and the depth sensing system is designed to emit and detect infrared light, and the depth sensing beam shaping optics provide optical compensation/correction for chromatic aberrations encountered for the infrared light.

15. The system as in claim 1, further comprising an outer dome having concentric spherical surfaces through which light enters the objective lens.

16. The system as in claim 1, wherein the objective lens is a first objective lens, the relay optical system is a first relay optical system, and the first objective lens and the first relay optical system comprise a first image channel, the first image channel further comprising a first housing coupled to the first objective lens and the first relay optical system, the system further comprising:
a second image channel adjacent the first image channel and comprising a second housing coupled to a second objective lens and a second relay optical system,
wherein the first housing and the second housing are separated by a seam width.

17. The system as in claim 16, further comprising:
a polygonal-shaped frame having a hollow center, wherein the first housing is coupled to a first face of the polygonal-shaped frame and the second housing is coupled to a second face of the polygonal-shaped frame, the second face being adjacent to the first face.

18. The system as in claim 17, wherein the first relay optical system extends at least partially into the hollow center and through an opening in a face of the polygonal-shaped frame opposite the first face, in which a gap between an outer surface of a last field lens element and a first subsequent relay lens elements of the relay optical system has a width that nominally matches a width of a hollow center of the internal polygonal shaped frame.

19. The system as in claim 1, wherein an aperture stop of the objective lens is imaged nominally to an aperture stop of the relay optical system.

20. The system as in claim 1, further comprising a display device proximate the secondary image plane, for displaying the magnified image as a projection display.
